(19) United States
(12) Patent Application Publication
(10) Pub. No.: US 2021/0303718 A1
(43) Pub. Date: Sep. 30, 2021

(54) CONTEXT BASED DATA LEAK PREVENTION OF SENSITIVE INFORMATION

(71) Applicant: Citrix Systems, Inc., Fort Lauderdale, FL (US)

(72) Inventor: Manbinder Pal Singh, Coral Springs, FL (US)

(21) Appl. No.: 16/835,928

(22) Filed: Mar. 31, 2020

(51) Int. Cl. G06F 21/62

(52) U.S. Cl. CPC G06F 21/6218

(57) ABSTRACT

Techniques are disclosed for context based data leak prevention of sensitive information. An example methodology implementing the techniques includes receiving, by a computing device, content for display, the computing device associated with a first user and, responsive to a determination that the content for display includes at least one item of sensitive information, adjusting, by the first computing device, at least one display attribute of the at least one item of sensitive information and displaying the at least one item of sensitive information with the adjusted at least one display attribute. Nonlimiting examples of display attributes include font size, font color, opacity, alpha blending, and zoom percentage. In some cases, the display attribute may be adjusted upon detecting a second user proximate to the computing device.

### BACKGROUND

Confidential, proprietary, or otherwise sensitive content may be accessed using a variety of devices, both personal and professional. For example, an organization may store confidential documents in network storage or in a cloud storage system or access confidential information using one or more Software-as-a-Service (SaaS) or remote desktop applications. An organization may grant its employees, contractors, agents, partners, or other persons associated with organization permission to access various types of content over a network, including word processing documents, spreadsheets, image files, text files, and Portable Document Format (PDF) files.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one example embodiment provided to illustrate the broader concepts, systems, and techniques described herein, a method includes receiving content for display and responsive to a determination that the content for display includes at least one item of sensitive information, adjusting at least one attribute of a device on which the at least one item of sensitive information is displayed such that the at least one item of sensitive information is displayed on the device with the at least one adjusted attribute.

With this particular arrangement, a technique for protecting sensitive information from being viewed by an unauthorized viewer (e.g. a person or an image capture device) is provided.

In accordance with another example embodiment provided to illustrate the broader concepts, systems, and techniques described herein, a method may include receiving, by a first computing device, content for display, the first computing device associated with a first user and, responsive to a determination that the content for display includes at least one item of sensitive information, adjusting, by the first computing device, at least one display attribute of the at least one item of sensitive information and displaying the at least one item of sensitive information with the adjusted at least one display attribute.

In one aspect, the at least one item of sensitive information is associated with a first font size and adjusting the at least one display attribute of the at least one item of sensitive information comprises adjusting the at least one item of sensitive information to a second font size, the second font size being different than the first font size.

In one aspect, the second font size is based on a proximity of a second user to the first computing device.

In one aspect, the at least one item of sensitive information is associated with a first font color and adjusting the at least one display attribute of the at least one item of sensitive information comprises adjusting the at least one item of sensitive information to a second font color, the second font color being different than the first font color.

In one aspect, the at least one item of sensitive information is associated with a first zoom percentage and adjusting the at least one display attribute of the at least one item of sensitive information comprises adjusting the at least one item of sensitive information to a second zoom percentage, the second zoom percentage being different than the first zoom percentage.

In one aspect, adjusting the at least one display attribute of the at least one item of sensitive information is responsive to determining, by the first computing device, that a second user is physically proximate the first computing device.

In one aspect, determining that the second user is physically proximate the first computing device comprises determining whether a second computing device associated with the second user is physically proximate the first computing device.

In one aspect, determining that the second user is physically proximate the first computing device includes use of image capture.

In one aspect, adjusting the at least one display attribute of the at least one item of sensitive information is responsive to determining, by the first computing device, that the first user is no longer interacting with the displayed at least one item of sensitive information.

In one aspect, determining that the first user is no longer interacting with the displayed at least one item of sensitive information includes use of facial recognition.

In one aspect, determining that the first user is no longer interacting with the displayed at least one item of sensitive information includes determining that a cursor of a pointing device is no longer proximate the displayed at least one item of sensitive information.

In one aspect, the at least one item of sensitive information is associated with a first display attribute and adjusting the at least one display attribute of the at least one item of sensitive information comprises adjusting the at least one item of sensitive information to a second display attribute, and the method may further include determining that the first user is interacting with the displayed at least one item of sensitive information and displaying the at least one item of sensitive information with the first display attribute.

In one aspect, determining that the first user is interacting with the displayed at least one item of sensitive information includes use of facial recognition.

In one aspect, determining that the first user is interacting with the displayed at least one item of sensitive information includes determining that a cursor of a pointing device is proximate the displayed at least one item of sensitive information.

In one aspect, the at least one item of sensitive information is associated with a first display attribute and adjusting the at least one display attribute of the at least one item of sensitive information comprises adjusting the at least one item of sensitive information to a second display attribute, and the method may further include responsive to a print command, displaying, by the first computing device, a print preview displaying the at least one item of sensitive information with the first display attribute.

In one aspect, the at least one item of sensitive information is associated with a first display attribute, and the method may further include responsive to a determination that the content for display includes at least one item of sensitive information, displaying, by the first computing device, the at least one item of sensitive information with the first display attribute on a mobile computing device associated with the first user.

According to another illustrative embodiment provided to illustrate the broader concepts described herein, a non-transitory machine-readable medium may encode instructions that when executed by one or more processors cause a process to be carried out. The process may include receiving content for display, the content for display requested by a user and, responsive to a determination that the content for display includes at least one item of sensitive information, adjusting at least one display attribute of the at least one item of sensitive information and causing displaying of the at least one item of sensitive information with the adjusted at least one display attribute.

In one aspect, the at least one display attribute includes one of a font size, a font color, opacity, alpha blending, or a zoom percentage.

In one aspect, adjusting the at least one display attribute of the at least one item of sensitive information is responsive to determining that the user is no longer interacting with the displayed at least one item of sensitive information.

According to another illustrative embodiment provided to illustrate the broader concepts, systems, and techniques described herein, a method may include receiving, by a computing device, content for display, the computing device associated with a first user, and the computing device being coupled to a plurality of monitors. The method may also include, responsive to a determination that the content for display includes at least one item of sensitive information, determining whether a second user is physically proximate the computing device. The method may further include, responsive to a determination that the second user is physically proximate the computing device, identifying a monitor of the plurality of monitors that is least viewable by the second user and displaying the content on the identified monitor.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 depicts an illustrative computer system architecture that may be used in accordance with one or more illustrative aspects of the concepts described herein.

FIG. 2 depicts an illustrative remote-access system architecture that may be used in accordance with one or more illustrative aspects of the concepts described herein.

FIG. 3 is a block diagram of a cloud computing environment in which various aspects of the disclosure may be implemented.

FIG. 4 is a block diagram illustrating selective components of an example computing device in which various aspects of the disclosure may be implemented, in accordance with an embodiment of the present disclosure.

FIG. 5 is a block diagram of an illustrative enterprise mobility management system, in accordance with an embodiment of the present disclosure.

FIG. 6 is a block diagram of an illustrative enterprise computing device management system, in accordance with an embodiment of the present disclosure.

FIG. 7 is a block diagram illustrating an example network environment in which a client device can prevent leakage of sensitive content, in accordance with an embodiment of the present disclosure.

FIG. 8 is a flow diagram of an example process for display of sensitive information based on physical proximity, in accordance with an embodiment of the present disclosure.

FIG. 9 is a flow diagram of an example process for determining a monitor a user is viewing, in accordance with an embodiment of the present disclosure.

### DETAILED DESCRIPTION

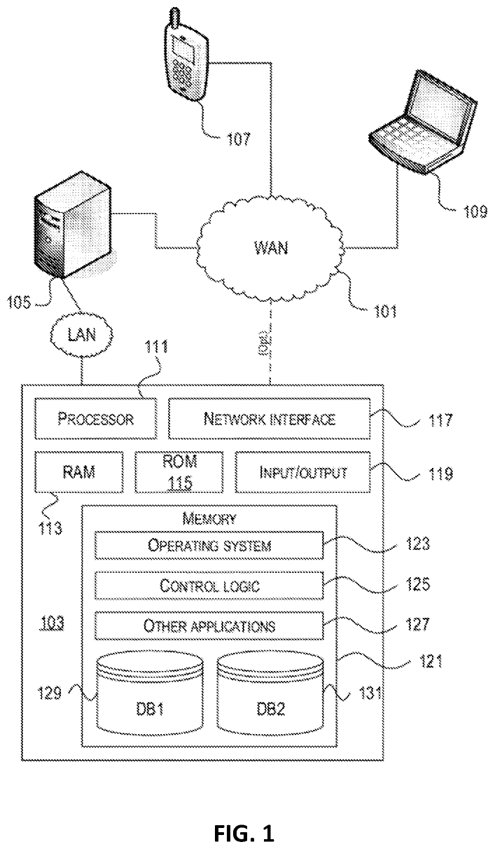

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects of the concepts described herein in a standalone and/or networked environment. Various network node devices 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topologies and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components and devices which make up the system of FIG. 1 may include a data server 103, a web server 105, and client computers 107, 109. Data server 103 provides overall access, control and administration of databases and control software for performing one or more illustrative aspects of the concepts described herein. Data server 103 may be connected to web server 105 through which users interact with and obtain data as requested. Alternatively, data server 103 may act as a web server itself and be directly connected to the Internet. Data server 103 may be connected to web server 105 through local area network 133, wide area network 101 (e.g., the Internet), via direct or indirect connection, or via some other network. Users may interact with data server 103 using remote computers 107, 109, e.g., using a web browser to connect to data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used in the system architecture and data processing device of FIG. 1, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of data server 103. Data server 103 may further include a random access memory (RAM) 113, a read only memory (ROM) 115, a network interface 117, input/output interfaces 119 (e.g., keyboard, mouse, display, printer, etc.), and a memory 121. Input/output (I/O) interfaces 119 may include a variety of interface units and drives for reading, writing, displaying, and/or printing data or files. Memory 121 may store operating system software 123 for controlling overall operation of the data server 103, control logic 125 for instructing data server 103 to perform aspects of the concepts described herein, and other application software 127 providing secondary, support, and/or other functionality which may or might not be used in conjunction with aspects of the concepts described herein. Control logic 125 may also be referred to herein as the data server software. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the concepts described herein. Memory 121 may include, for example, a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, and 109 may have similar or different architecture as described with respect to data server 103. Those of skill in the art will appreciate that the functionality of data server 103 (or device 105, 107, or 109) as described herein may be spread across multiple data processing devices, for example, to distribute processing load across multiple computers, to segregate transactions based on geographic location, user access level, quality of service (QoS), etc.

One or more aspects of the concepts described here may be embodied as computer-usable or readable data and/or as computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution or may be written in a scripting language such as (but not limited to) Hypertext Markup Language (HTML) or Extensible Markup Language (XML). The computer executable instructions may be stored on a computer readable storage medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source node and a destination node (e.g., the source node can be a storage or processing node having information stored therein which information can be transferred to another node referred to as a “destination node”). The media can be transferred in the form of electromagnetic waves traveling through signal-conducting media such as metal wires, optical fibers, and/or wireless transmission media (e.g., air and/or space). Various aspects of the concepts described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the concepts described herein, and such data structures are contemplated within the scope of computer executable instructions and computer-usable data described herein.

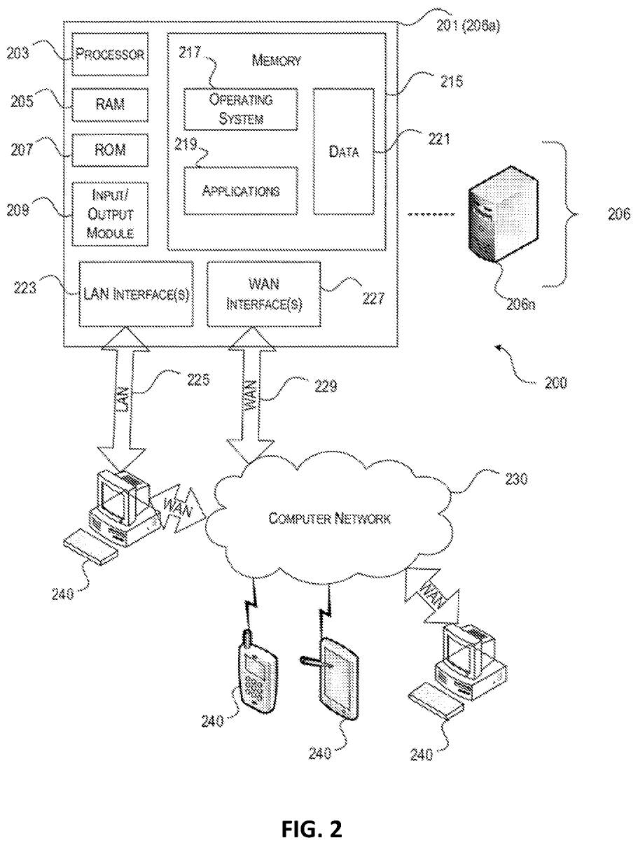

With further reference to FIG. 2, one or more aspects of the concepts described herein may be implemented in a remote-access environment. FIG. 2 depicts an example system architecture including a computing device 201 in an illustrative computing environment 200 that may be used according to one or more illustrative aspects of the concepts described herein. Computing device 201 may be used as a server 206a in a single-server or multi-server desktop virtualization system (e.g., a remote access or cloud system) configured to provide virtual machines (VMs) for client access devices. Computing device 201 may have a processor 203 for controlling overall operation of the server and its associated components, including a RAM 205, a ROM 207, an input/output (I/O) module 209, and a memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices). Terminals 240 may be personal computers, mobile devices, laptop computers, tablets, or servers that include many or all the elements described above with respect to data server 103 or computing device 201. The network connections depicted in FIG. 2 include a local area network (LAN) 225 and a wide area network (WAN) 229 but may also include other networks. When used in a LAN networking environment, computing device 201 may be connected to LAN 225 through an adapter or network interface 223. When used in a WAN networking environment, computing device 201 may include a modem or other wide area network interface 227 for establishing communications over WAN 229, such as to computer network 230 (e.g., the Internet). It will be appreciated that the network connections shown are illustrative and other means of establishing a communication link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects of the concepts described herein may also be operational with numerous other general purpose or special purpose computing system environments or configurations. Examples of other computing systems, environments, and/or configurations that may be suitable for use with aspects of the concepts described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more terminals 240 may be in communication with one or more servers 206a-206n (generally referred to herein as “server(s) 206”). In one embodiment, computing environment 200 may include a network appliance installed between server(s) 206 and terminals 240. The network appliance may manage client/server connections, and in some cases can load balance client connections amongst a plurality of back-end servers 206.

Terminals 240 may in some embodiments be referred to as a single computing device or a single group of client computing devices, while server(s) 206 may be referred to as a single server 206 or a group of servers 206. In one embodiment, a single terminal 240 communicates with more than one server 206, while in another embodiment a single server 206 communicates with more than one terminal 240. In yet another embodiment, a single terminal 240 communicates with a single server 206.

Terminal 240 can, in some embodiments, be referred to as any one of the following non-exhaustive terms: client machine(s); client(s); client computer(s); client device(s); client computing device(s); local machine; remote machine; client node(s); endpoint(s); or endpoint node(s). Server 206, in some embodiments, may be referred to as any one of the following non-exhaustive terms: server(s), local machine; remote machine; server farm(s), or host computing device(s).

In one embodiment, terminal 240 may be a VM. The VM may be any VM, while in some embodiments the VM may be any VM managed by a Type 1 or Type 2 hypervisor, for example, a hypervisor developed by Citrix Systems, IBM, VMware, or any other hypervisor. In some aspects, the VM may be managed by a hypervisor, while in other aspects the VM may be managed by a hypervisor executing on server 206 or a hypervisor executing on terminal 240.

Some embodiments include a terminal, such as terminal 240, that displays application output generated by an application remotely executing on a server, such as server 206, or other remotely located machine. In these embodiments, terminal 240 may execute a VM receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

Server 206, in some embodiments, uses a remote presentation protocol or other program to send data to a thin-client or remote-display application executing on the client to present display output generated by an application executing on server 206. The thin-client or remote-display protocol can be any one of the following non-exhaustive list of protocols: the Independent Computing Architecture (ICA) protocol developed by Citrix Systems, Inc. of Fort Lauderdale, Fla.; or the Remote Desktop Protocol (RDP) manufactured by Microsoft Corporation of Redmond, Wash.

A remote computing environment may include more than one server 206a-206n logically grouped together into a server farm 206, for example, in a cloud computing environment. Server farm 206 may include servers 206a-206n that are geographically dispersed while logically grouped together, or servers 206a-206n that are located proximate to each other while logically grouped together. Geographically dispersed servers 206a-206n within server farm 206 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments, server farm 206 may be administered as a single entity, while in other embodiments server farm 206 can include multiple server farms.

In some embodiments, server farm 206 may include servers that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server, a master application server, a server executing an active directory, or a server executing an application acceleration program that provides firewall functionality, application functionality, or load balancing functionality. Other server types may also be used.

Some embodiments include a first server 206a that receives requests from terminal 240, forwards the request to a second server 206b (not shown), and responds to the request generated by terminal 240 with a response from second server 206b (not shown). First server 206a may acquire an enumeration of applications available to terminal 240 as well as address information associated with an application server 206 hosting an application identified within the enumeration of applications. First server 206a can present a response to the client's request using a web interface and communicate directly with terminal 240 to provide terminal 240 with access to an identified application. One or more terminals 240 and/or one or more servers 206 may transmit data over network 230, e.g., network 101.

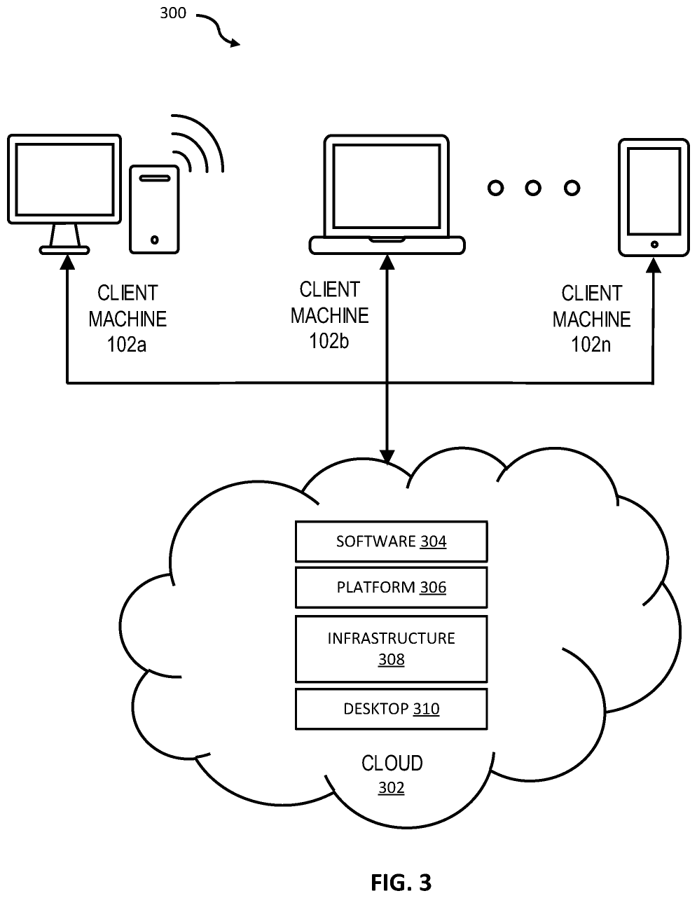

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 302. Cloud network 302 may include back-end platforms, e.g., servers, storage, server farms or data centers. The users or clients 102a-102n can correspond to a single organization/tenant or multiple organizations/tenants. More particularly, in one example implementation cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a Service (SaaS) 304, Platform as a Service (PaaS) 306, Infrastructure as a Service (IaaS) 308, and Desktop as a Service (DaaS) 310, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

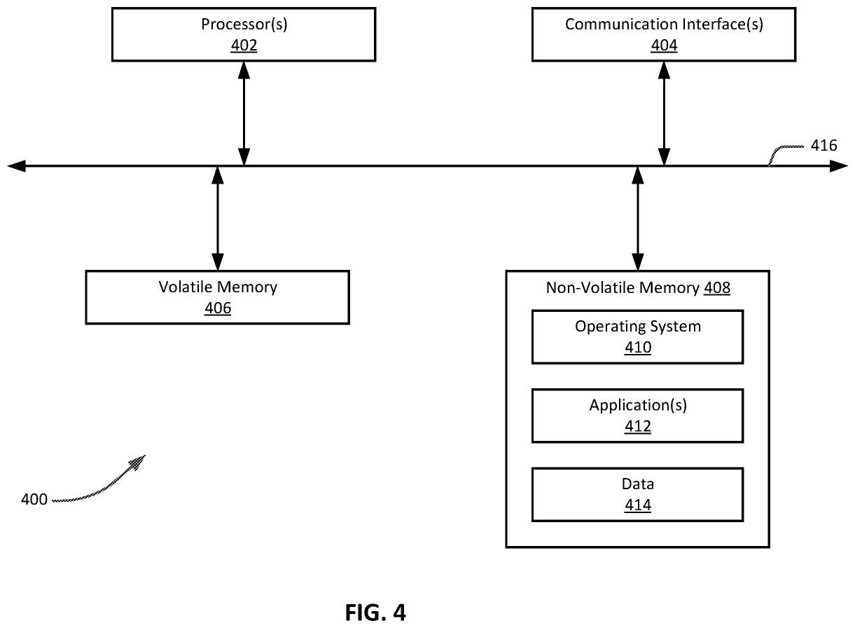

FIG. 4 is a block diagram illustrating selective components of an example computing device 400 in which various aspects of the disclosure may be implemented, in accordance with an embodiment of the present disclosure. Computing device 400 is shown merely as an example of components 103, 105, 107, and 109 of FIG. 1, computing device 201 and terminals 240 of FIG. 2, and/or client machines 102a-102n of FIG. 3, for instance. However, the illustrated computing device 400 is shown merely as an example and one skilled in the art will appreciate that components 103, 105, 107, and 109 of FIG. 1, computing device 201 and terminals 240 of FIG. 2, and/or client machines 102a-102n of FIG. 3 may be implemented by any computing or processing environment and with any type of machine or set of machines that may have suitable hardware and/or software capable of operating as described herein.

As shown in FIG. 4, computing device 400 includes one or more processor(s) 402, one or more communication interface(s) 404, a volatile memory 406 (e.g., random access memory (RAM)), a non-volatile memory 408, and a communications bus 416.

Non-volatile memory 408 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

Non-volatile memory 408 stores an operating system 410, one or more applications 412, and data 414 such that, for example, computer instructions of operating system 410 and/or applications 412 are executed by processor(s) 402 out of volatile memory 406. For example, in some embodiments, applications 412 may cause computing device 400 to implement functionality in accordance with the various embodiments and/or examples described herein. In some embodiments, volatile memory 406 may include one or more types of RAM and/or a cache memory that may offer a faster response time than a main memory. Data may be entered using an input device of computing device 400 or received from I/O device(s) communicatively coupled to computing device 400. Various elements of computing device 400 may communicate via communications bus 416.

Processor(s) 402 may be implemented by one or more programmable processors to execute one or more executable instructions, such as applications 412 and/or a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, processor 402 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 402 may be analog, digital or mixed signal. In some embodiments, processor 402 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communication interface(s) 404 may include one or more interfaces to enable computing device 400 to access a computer network such as a Local Area Network (LAN), a Wide Area Network (WAN), a Personal Area Network (PAN), or the Internet through a variety of wired and/or wireless connections, including cellular connections.

In described embodiments, computing device 400 may execute an application on behalf of a user of a client device. For example, computing device 400 may execute one or more virtual machines managed by a hypervisor. Each virtual machine may provide an execution session within which applications execute on behalf of a user or a client device, such as a hosted desktop session. Computing device 400 may also execute a terminal services session to provide a hosted desktop environment. Computing device 400 may provide access to a remote computing environment including one or more applications, one or more desktop applications, and one or more desktop sessions in which one or more applications may execute.

For example, in some embodiments, a first computing device 400 may execute an application on behalf of a user of a client computing device (e.g., client 107 or 109 of FIG. 1), may execute a VM, which provides an execution session within which applications execute on behalf of a user or a client computing device (e.g., any of client machines 102a-102n of FIG. 3), such as a hosted desktop session, may execute a terminal services session to provide a hosted desktop environment, or may provide access to a computing environment including one or more of: one or more applications, one or more desktop applications, and one or more desktop sessions in which one or more applications may execute.

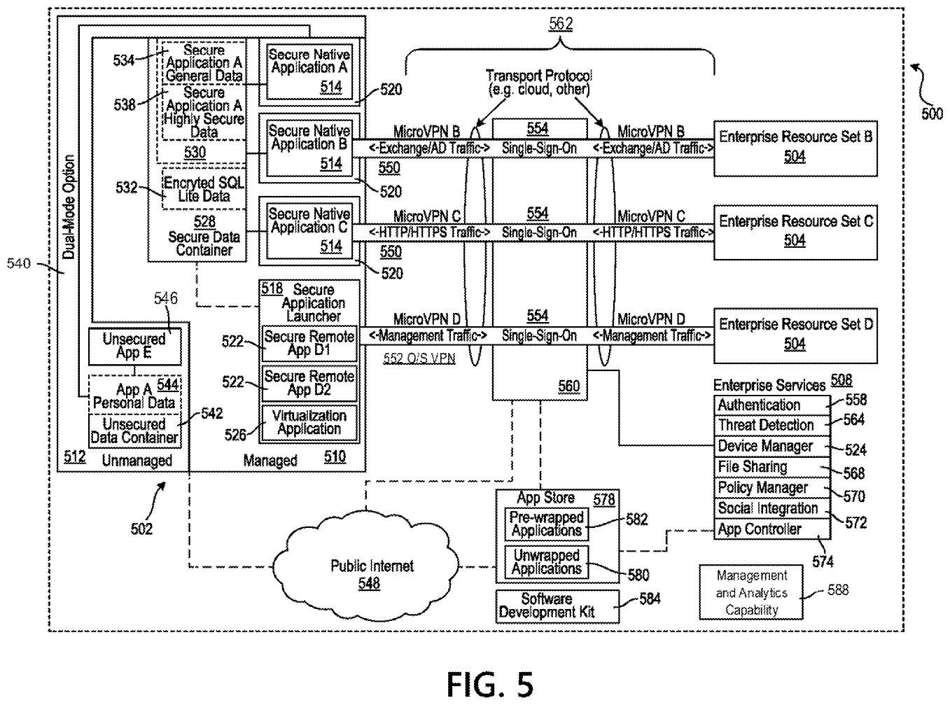

FIG. 5 depicts an illustrative enterprise mobility management system 500, in accordance with an embodiment of the present disclosure. For example, mobility management system 500 may be used in or to implement an enterprise mobile computing environment. In an example use case, mobility management system 500 enables a user of a mobile device 502 to both access enterprise or personal resources from mobile device 502 and use mobile device 502 for personal use. The user may access such enterprise resources 504 or enterprise services 508 using a mobile device 502 that is purchased by the user or a mobile device 502 that is provided by the enterprise to the user. The user may utilize mobile device 502 for business use only or for business and personal use. Mobile device 502 may run an iOS operating system, an Android operating system, or the like. The enterprise may choose to implement policies to manage mobile device 502. The policies may be implemented through a firewall or gateway in such a way that mobile device 502 may be identified, secured, or security verified, and provided selective or full access to the enterprise resources (e.g., 504 and 508). The policies may be mobile device management policies, mobile application management policies, mobile data management policies, or some combination of mobile device, application, and data management policies. A mobile device 502 that is managed through the application of mobile device management policies may be referred to as an enrolled device.

In some embodiments, the operating system of mobile device 502 may be separated into a managed partition 510 and an unmanaged partition 512. Managed partition 510 may have policies applied to it to secure the applications running on and data stored in managed partition 510. The applications running on managed partition 510 may be secure applications. In other embodiments, these applications may execute in accordance with a set of one or more policy files received separate from the application, and which define one or more security parameters, features, resource restrictions, and/or other access controls that are enforced by the mobile device management system when that application is executing on mobile device 502.

By operating in accordance with their respective policy file(s), each application may be allowed or restricted from communications with one or more other applications and/or resources, thereby creating a virtual partition. Thus, as used herein, a partition may refer to a physically partitioned portion of memory (physical partition), a logically partitioned portion of memory (logical partition), and/or a virtual partition created as a result of enforcement of one or more policies and/or policy files across multiple applications as described herein (virtual partition). Stated differently, by enforcing policies on managed applications, those applications may be restricted to only be able to communicate with other managed applications and trusted enterprise resources, thereby creating a virtual partition that is not accessible by unmanaged applications and devices.

The secure applications may be email applications, web browsing applications, software-as-a-service (SaaS) access applications, Windows Application access applications, and the like. The secure applications may be secure native applications 514, secure remote applications 522 executed by a secure application launcher 518, virtualization applications 526 executed by a secure application launcher 518, and the like. Secure native applications 514 may be wrapped by a secure application wrapper 520.

Secure application wrapper 520 may include integrated policies that are executed on mobile device 502 when secure native application 514 is executed on mobile device 502. Secure application wrapper 520 may include metadata that points secure native application 514 running on mobile device 502 to the resources hosted at the enterprise (e.g., 504 and 508) that secure native application 514 may require to complete the task requested upon execution of secure native application 514. Secure remote applications 522 executed by a secure application launcher 518 may be executed within secure application launcher 518. Virtualization applications 526 executed by secure application launcher 518 may utilize resources on mobile device 502, at enterprise resources 504, and the like.

The resources used on mobile device 502 by virtualization applications 526 executed by secure application launcher 518 may include user interaction resources, processing resources, and the like. The user interaction resources may be used to collect and transmit keyboard input, mouse input, camera input, tactile input, audio input, visual input, gesture input, and the like. The processing resources may be used to present a user interface, process data received from enterprise resources 504, and the like. The resources used at enterprise resources 504 by virtualization applications 526 executed by secure application launcher 518 may include user interface generation resources, processing resources, and the like. The user interface generation resources may be used to assemble a user interface, modify a user interface, refresh a user interface, and the like. The processing resources may be used to create information, read information, update information, delete information, and the like.

For example, virtualization application 526 may record user interactions associated with a graphical user interface (GUI) and communicate them to a server application where the server application uses the user interaction data as an input to the application operating on the server. In such an arrangement, an enterprise may elect to maintain the application on the server side as well as data, files, etc. associated with the application. While an enterprise may elect to “mobilize” some applications in accordance with the principles herein by securing them for deployment on mobile device 502, this arrangement may also be elected for certain applications.

For example, while some applications may be secured for use on mobile device 502, others might not be prepared or appropriate for deployment on mobile device 502 so the enterprise may elect to provide the mobile user access to the unprepared applications through virtualization techniques. As another example, the enterprise may have large complex applications with large and complex data sets (e.g., material resource planning applications) where it would be very difficult, or otherwise undesirable, to customize the application for mobile device 502 so the enterprise may elect to provide access to the application through virtualization techniques. As yet another example, the enterprise may have an application that maintains highly secured data (e.g., human resources data, customer data, engineering data) that may be deemed by the enterprise as too sensitive for even the secured mobile environment so the enterprise may elect to use virtualization techniques to permit mobile access to such applications and data.

An enterprise may elect to provide both fully secured and fully functional applications on mobile device 502 as well as virtualization application 526 to allow access to applications that are deemed more properly operated on the server side. In an embodiment, virtualization application 526 may store some data, files, etc. on mobile device 502 in one of the secure storage locations. An enterprise, for example, may elect to allow certain information to be stored on mobile device 502 while not permitting other information.

In connection with virtualization application 526, as described herein, mobile device 502 may have virtualization application 526 that is designed to present GUIs and then record user interactions with the GUI. Virtualization application 526 may communicate the user interactions to the server side to be used by the server side application as user interactions with the application. In response, the application on the server side may transmit back to mobile device 502 a new GUI. For example, the new GUI may be a static page, a dynamic page, an animation, or the like, thereby providing access to remotely located resources.

Secure applications 514 may access data stored in a secure data container 528 in managed partition 510 of mobile device 502. The data secured in the secure data container may be accessed by secure native applications 514, secure remote applications 522 executed by secure application launcher 518, virtualization applications 526 executed by secure application launcher 518, and the like. The data stored in secure data container 528 may include files, databases, and the like. The data stored in secure data container 528 may include data restricted to a specific secure application 530, shared among secure applications 532, and the like.

Data restricted to a secure application may include secure general data 534 and highly secure data 538. Secure general data may use a strong form of encryption such as Advanced Encryption Standard (AES) 128-bit encryption or the like, while highly secure data 538 may use a very strong form of encryption such as AES 256-bit encryption. Data stored in secure data container 528 may be deleted from mobile device 502 upon receipt of a command from device manager 524. The secure applications (e.g., 514, 522, and 526) may have a dual-mode option 540.

Dual mode option 540 may present the user with an option to operate the secured application in an unsecured or unmanaged mode. In an unsecured or unmanaged mode, the secure applications may access data stored in an unsecured data container 542 on unmanaged partition 512 of mobile device 502. The data stored in an unsecured data container may be personal data 544. The data stored in unsecured data container 542 may also be accessed by unsecured applications 546 that are running on unmanaged partition 512 of mobile device 502. The data stored in unsecured data container 542 may remain on mobile device 502 when the data stored in secure data container 528 is deleted from mobile device 502.

An enterprise may want to delete from mobile device 502 selected or all data, files, and/or applications owned, licensed or controlled by the enterprise (enterprise data) while leaving or otherwise preserving personal data, files, and/or applications owned, licensed or controlled by the user (personal data). This operation may be referred to as a selective wipe. With the enterprise and personal data arranged in accordance to the aspects described herein, an enterprise may perform a selective wipe.

Mobile device 502 may connect to enterprise resources 504 and enterprise services 508 at an enterprise, to public Internet 548, and the like. Mobile device 502 may connect to enterprise resources 504 and enterprise services 508 through virtual private network connections. The virtual private network connections, also referred to as microVPN or application-specific VPN, may be specific to particular applications (as illustrated by microVPNs 550, particular devices, particular secured areas on the mobile device (as illustrated by O/S VPN 552), and the like. For example, each of the wrapped applications in the secured area of mobile device 502 may access enterprise resources through an application specific VPN such that access to the VPN would be granted based on attributes associated with the application, possibly in conjunction with user or device attribute information.

The virtual private network connections may carry Microsoft Exchange traffic, Microsoft Active Directory traffic, HyperText Transfer Protocol (HTTP) traffic, HyperText Transfer Protocol Secure (HTTPS) traffic, application management traffic, and the like. The virtual private network connections may support and enable single-sign-on authentication processes 554. The single-sign-on processes may allow a user to provide a single set of authentication credentials, which are then verified by an authentication service 558. Authentication service 558 may then grant to the user access to multiple enterprise resources 504, without requiring the user to provide authentication credentials to each individual enterprise resource 504.

The virtual private network connections may be established and managed by an access gateway 560. Access gateway 560 may include performance enhancement features that manage, accelerate, and improve the delivery of enterprise resources 504 to mobile device 502. Access gateway 560 may also re-route traffic from mobile device 502 to public Internet 548, enabling mobile device 502 to access publicly available and unsecured applications that run on public Internet 548. Mobile device 502 may connect to the access gateway via a transport network 562. Transport network 562 may use one or more transport protocols and may be a wired network, wireless network, cloud network, local area network, metropolitan area network, wide area network, public network, private network, and the like.

Enterprise resources 504 may include email servers, file sharing servers, SaaS applications, Web application servers, Windows application servers, and the like. Email servers may include Exchange servers, Lotus Notes servers, and the like. File sharing servers may include ShareFile servers, and the like. SaaS applications may include Salesforce, and the like. Windows application servers may include any application server that is built to provide applications that are intended to run on a local Windows operating system, and the like. Enterprise resources 504 may be premise-based resources, cloud-based resources, and the like. Enterprise resources 504 may be accessed by mobile device 502 directly or through access gateway 560. Enterprise resources 504 may be accessed by mobile device 502 via transport network 562.

Enterprise services 508 may include authentication services 558, threat detection services 564, device manager services 524, file sharing services 568, policy manager services 570, social integration services 572, application controller services 574, and the like. Authentication services 558 may include user authentication services, device authentication services, application authentication services, data authentication services, and the like. Authentication services 558 may use certificates. The certificates may be stored on mobile device 502, by enterprise resources 504, and the like. The certificates stored on mobile device 502 may be stored in an encrypted location on mobile device 502, the certificate may be temporarily stored on mobile device 502 for use at the time of authentication, and the like. Threat detection services 564 may include intrusion detection services, unauthorized access attempt detection services, and the like. Unauthorized access attempt detection services may include unauthorized attempts to access devices, applications, data, and the like. Device management services 524 may include configuration, provisioning, security, support, monitoring, reporting, and decommissioning services. File sharing services 568 may include file management services, file storage services, file collaboration services, and the like. Policy manager services 570 may include device policy manager services, application policy manager services, data policy manager services, and the like. Social integration services 572 may include contact integration services, collaboration services, integration with social networks such as Facebook, Twitter, and LinkedIn, and the like. Application controller services 574 may include management services, provisioning services, deployment services, assignment services, revocation services, wrapping services, and the like.

Mobility management system 500 may include an application store 578. Application store 578 may include unwrapped applications 580, pre-wrapped applications 582, and the like. Applications may be populated in application store 578 from application controller 574. Application store 578 may be accessed by mobile device 502 through access gateway 560, through public Internet 548, or the like. Application store 578 may be provided with an intuitive and easy to use user interface.

A software development kit 584 may provide a user the capability to secure applications selected by the user by wrapping the application as described previously in this description. An application that has been wrapped using software development kit 584 may then be made available to mobile device 502 by populating it in application store 578 using application controller 574.

Mobility management system 500 may include a management and analytics capability 588. Management and analytics capability 588 may provide information related to how resources are used, how often resources are used, and the like. Resources may include devices, applications, data, and the like. How resources are used may include which devices download which applications, which applications access which data, and the like. How often resources are used may include how often an application has been downloaded, how many times a specific set of data has been accessed by an application, and the like.

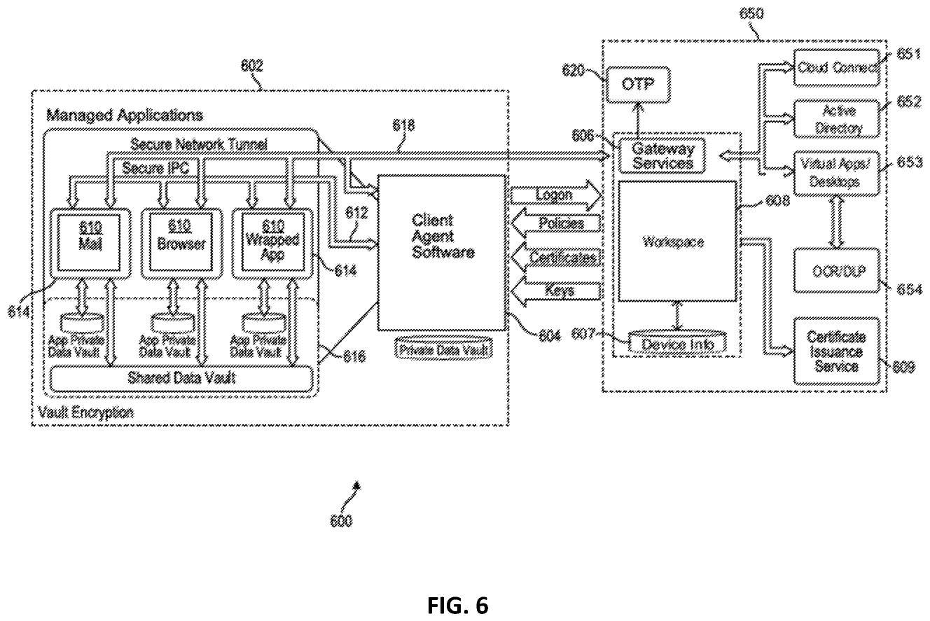

FIG. 6 depicts an illustrative enterprise computing device management system 600, in accordance with an embodiment of the present disclosure. For example, computing device management system 600 may be used in or to implement an enterprise computing environment. Some of the components of mobility management system 500 described above with reference to FIG. 5 have been omitted for the sake of simplicity. The architecture of system 600 depicted in FIG. 6 is similar in many respects to the architecture of mobility management system 500 described above with reference to FIG. 5 and may include additional features not mentioned above.

As can be seen, the left side of FIG. 6 represents an enrolled computing device 602 with a client agent 604, which interacts with a gateway server 606 (which includes Access Gateway and application controller functionality) to access various virtual apps/desktops 653 and other resources, such as an active directory (AD) 652 resource, as shown on the right side of FIG. 6. Computing device 602 may be a mobile computing device, such as mobile device 502, or a stationary (e.g., non-mobile) computing device. Examples of mobile computing devices include a smartphone, tablet, laptop computer, notebook computer, smart watch, and personal digital assistant (PDA), to name a few examples. Examples of stationary computing devices include a desktop computer, workstation, and a smart TV, to name several examples. The services and components on the right side of FIG. 6 may collectively be referred to as a sensitive content management system 650, the functions of which are described in more detail below.

Client agent 604 may act as the UI (user interface) intermediary for virtual apps/desktops 653 hosted by sensitive content management system 650, which may be accessed using the High-Definition User Experience (HDX)/ICA display remoting protocol. Client agent 604 may also support the installation and management of native applications on computing device 602, such as native WINDOWS, macOS, iOS, or ANDROID applications. For example, managed applications 610 (mail, browser, wrapped application) shown in FIG. 6 may be native applications that execute locally on computing device 602. Client agent 604 and application management framework of this architecture may act to provide policy driven management capabilities and features such as connectivity and single sign-on (SSO) to enterprise resources/services (e.g., virtual apps/desktops 653, active directory 652). Client agent 604 may handle primary user authentication to the enterprise, normally to Access Gateway (AG) 606 with SSO to other gateway server components. Client agent 604 may obtain policies from gateway server 606 to control the behavior of managed applications 610 on computing device 602.

Secure InterProcess Communication (IPC) links 612 between native applications 610 and client agent 604 represent a management channel, which may allow a client agent to supply policies to be enforced by an application management framework 614 “wrapping” each application. IPC channel 612 may also allow client agent 604 to supply credential and authentication information that enables connectivity and SSO to enterprise resources (e.g., virtual apps/desktops 653, active directory 652). In addition, IPC channel 612 may allow application management framework 614 to invoke user interface functions implemented by client agent 604, such as online and offline authentication.

Communications between client agent 604 and gateway server 606 may be essentially an extension of the management channel from application management framework 614 wrapping each native managed application 610. Application management framework 614 may request policy information from client agent 604, which in turn may request it from gateway server 606. Application management framework 614 may request authentication, and client agent 604 may log into the gateway services part of gateway server 606 (also known as NETSCALER ACCESS GATEWAY). Client agent 604 may also call supporting services on gateway server 606, which may produce input material to derive encryption keys for local data vaults 616 or may provide client certificates which may enable direct authentication to PKI protected resources, as more fully explained below.

In more detail, application management framework 614 “wraps” each managed application 610. This may be incorporated via an explicit build operation or step, or via a post-build processing operation or step. Application management framework 614 may “pair” with client agent 604 on first launch of an application 610 to initialize secure IPC channel 612 and obtain the policy for that application. Application management framework 614 may enforce relevant portions of the policy that apply locally, such as the client agent login dependencies and some of the containment policies that restrict how local OS services may be used, or how they may interact with managed application 610.

Application management framework 614 may use services provided by client agent 604 over secure IPC channel 612 to facilitate authentication and internal network access. Key management for the private and shared data vaults 616 (containers) may be also managed by appropriate interactions between managed applications 610 and client agent 604. Vaults 616 may be available only after online authentication or may be made available after offline authentication if allowed by policy. First use of vaults 616 may require online authentication, and offline access may be limited to at most the policy refresh period before online authentication is again required.

Network access to internal resources may occur directly from individual managed applications 610 through Access Gateway 606. Application management framework 614 may be responsible for orchestrating the network access on behalf of each managed application 610. Client agent 604 may facilitate these network connections by providing suitable time limited secondary credentials obtained following online authentication. Multiple modes of network connection may be used, such as reverse web proxy connections and end-to-end VPN-style tunnels 618.

Mail and Browser managed applications 610 may have special status and may make use of facilities that might not be generally available to arbitrary wrapped applications. For example, Mail application 610 may use a special background network access mechanism that allows it to access an exchange server (not shown) over an extended period of time without requiring a full AG logon. Browser application 610 may use multiple private data vaults 616 to segregate different kinds of data.

This architecture may support the incorporation of various other security features. For example, gateway server 606 (including its gateway services) in some cases may not need to validate active directory (AD) passwords. It can be left to the discretion of an enterprise whether an AD password may be used as an authentication factor for some users in some situations. Different authentication methods may be used if a user is online or offline (i.e., connected or not connected to a network).

Step up authentication is a feature wherein gateway server 606 may identify managed native applications 610 that are allowed to have access to highly classified data requiring strong authentication, and ensure that access to these applications is only permitted after performing appropriate authentication, even if this means a re-authentication is required by the user after a prior weaker level of login.

Another security feature of this solution is the encryption of data vaults 616 (containers) on computing device 602. Vaults 616 may be encrypted so that all on-device data including files, databases, and configurations are protected. For on-line vaults, the keys may be stored on a server (e.g., gateway server 606), and for off-line vaults, a local copy of the keys may be protected by a user password or biometric validation. If or when data is stored locally on computing device 602 in secure container 616, a minimum of AES 256 encryption algorithm may be utilized, although other suitable encryption algorithms may be used.

Other secure container features may also be implemented. For example, a logging feature may be included, wherein security events happening inside managed application 610 may be logged and reported to the backend. Data wiping may be supported, such as if or when managed application 610 detects tampering, associated encryption keys may be written over with random data, leaving no hint on the file system that user data was destroyed. Screenshot protection may be another feature, where an application may prevent any data from being stored in screenshots. For example, the key window's hidden property may be set to YES. This may cause whatever content is currently displayed on the screen to be hidden, resulting in a blank screenshot where any content would normally reside.

Local data transfer may be prevented, such as by preventing any data from being locally transferred outside the application container, e.g., by copying it or sending it to an external application. A keyboard cache feature may operate to disable the autocorrect functionality for sensitive text fields. SSL certificate validation may be operable so the application specifically validates the server SSL certificate instead of it being stored in the keychain. An encryption key generation feature may be used such that the key used to encrypt data on computing device 602 is generated using a passphrase or biometric data supplied by the user (if offline access is required). It may be XORed with another key randomly generated and stored on the server side if offline access is not required. Key Derivation functions may operate such that keys generated from the user password use KDFs (key derivation functions, notably Password-Based Key Derivation Function 2 (PBKDF2)) rather than creating a cryptographic hash of it. The latter makes a key susceptible to brute force or dictionary attacks.

Further, one or more initialization vectors may be used in encryption methods. An initialization vector can cause multiple copies of the same encrypted data to yield different cipher text output, preventing both replay and cryptanalytic attacks. This can also prevent an attacker from decrypting any data even with a stolen encryption key. Further, authentication then decryption may be used, wherein application data is decrypted only after the user has authenticated within the application. Another feature may relate to sensitive data in memory, which may be kept in memory (and not in disk) only when it's needed. For example, login credentials may be wiped from memory after login, and encryption keys and other data inside objective-C instance variables are not stored, as they may be easily referenced. Instead, memory may be manually allocated for these.

An inactivity timeout may be implemented, wherein after a policy-defined period of inactivity, a user session is terminated.

Data leakage from application management framework 614 may be prevented in other ways. For example, if or when a managed application 610 is put in the background, the memory may be cleared after a predetermined (configurable) time period. When backgrounded, a snapshot may be taken of the last displayed screen of the application to fasten the foregrounding process. The screenshot may contain confidential data and hence should be cleared.

Another security feature may relate to the use of an OTP (one time password) 620 without the use of AD 652 password for access to one or more applications. In some cases, some users do not know (or are not permitted to know) their AD password, so these users may authenticate using OTP 620 such as by using a hardware OTP system like SecurID (OTPs may be provided by different vendors also, such as Entrust or Gemalto). In some cases, after a user authenticates with a user ID, a text may be sent to the user with an OTP 620. In some cases, this may be implemented only for online use, with a prompt being a single field.

An offline password may be implemented for offline authentication for those managed applications 610 for which offline use is permitted via enterprise policy. For example, an enterprise may want StoreFront to be accessed in this manner. In this case, client agent 604 may require the user to set a custom offline password and the AD password is not used. Gateway server 606 may provide policies to control and enforce password standards with respect to the minimum length, character class composition, and age of passwords, such as described by the standard Windows Server password complexity requirements, although these requirements may be modified.

Another feature may relate to the enablement of a client side certificate for certain applications 610 as secondary credentials (for the purpose of accessing PKI protected web resources via the application management framework micro VPN feature). For example, managed application 610 may utilize such a certificate. In this case, certificate-based authentication using ActiveSync protocol may be supported, wherein a certificate from client agent 604 may be retrieved by gateway server 606 and used in a keychain. Each managed application 610 may have one associated client certificate, identified by a label that is defined in gateway server 606.

Gateway server 606 may interact with an enterprise special purpose web service to support the issuance of client certificates to allow relevant managed applications to authenticate to internal PKI protected resources.

Client agent 604 and application management framework 614 may be enhanced to support obtaining and using client certificates for authentication to internal PKI protected network resources. More than one certificate may be supported, such as to match various levels of security and/or separation requirements. The certificates may be used by Mail and Browser managed applications 610, and ultimately by arbitrary wrapped applications 610 (provided those applications use web service style communication patterns where it is reasonable for the application management framework to mediate HTTPS requests).

Application management client certificate support on iOS may rely on importing a public-key cryptography standards (PKCS) 12 BLOB (Binary Large Object) into the iOS keychain in each managed application 610 for each period of use. Application management framework client certificate support may use a HTTPS implementation with private in-memory key storage. The client certificate may not be present in the iOS keychain and may not be persisted except potentially in “online-only” data value that is strongly protected.

Mutual SSL or TLS may also be implemented to provide additional security by requiring that computing device 602 is authenticated to the enterprise, and vice versa. Virtual smart cards for authentication to gateway server 606 may also be implemented.

Another feature may relate to application container locking and wiping, which may automatically occur upon jailbreak or rooting detections, and occur as a pushed command from administration console, and may include a remote wipe functionality even when managed application 610 is not running.

A multi-site architecture or configuration of enterprise application store and an application controller may be supported that allows users to be serviced from one of several different locations in case of failure.

In some cases, managed applications 610 may be allowed to access a certificate and private key via an API (for example, OpenSSL). Trusted managed applications 610 of an enterprise may be allowed to perform specific Public Key operations with an application's client certificate and private key. Various use cases may be identified and treated accordingly, such as if or when an application behaves like a browser and no certificate access is required, if or when an application reads a certificate for “who am I,” if or when an application uses the certificate to build a secure session token, and if or when an application uses private keys for digital signing of important data (e.g., transaction log) or for temporary data encryption.

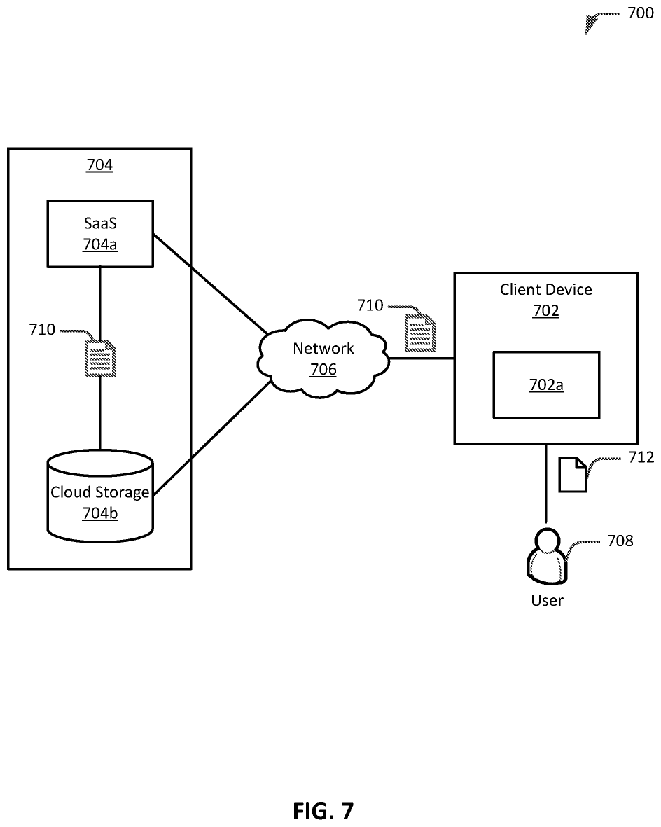

FIG. 7 is a block diagram illustrating an example network environment 700 in which a client device 702 can prevent leakage of sensitive content, in accordance with an embodiment of the present disclosure. More specifically, in some embodiments, client device 702 may be understood as preventing sensitive content leakage or loss based on a contextual factor or factors that provide an indication of the vulnerability of displayed sensitive content to potential data leakage or loss. Such contextual factors include, but are not limited to, display of sensitive content, physical proximity of another user or another observer near the display of the sensitive content, and inactivity (i.e., idle) status of an application being used to access and/or interact with the sensitive content.

As illustrated in FIG. 7, network environment 700 can include one or more client devices 702 communicably coupled to one or more cloud services 704 via a network 706. Network 706 may correspond one or more to wireless or wired computer networks including, but not limited to, local-area networks (LANs), metropolitan area networks (MANs), wide area networks (WANs), wireless local-area networks (WLAN), primary public networks, primary private networks, cellular networks, Wi-Fi (i.e., 802.11) networks, Bluetooth networks, and Near Field Communication (NFC) networks. In some embodiments, network 706 may include another network or a portion or portions of other networks.

Network environment 700 may provide services for one or more organizations, with the organizations having one or more associated users. A given client device 702 may be assigned to or otherwise associated with a particular user. For example, as shown in FIG. 7, client device 702 may be assigned to, or associated with, a user 708. While only one client device 702 and one corresponding user 708 are shown in FIG. 7, the structures and techniques sought to be protected herein can be applied to any number of organizations, users, and devices.

Client device 702 can include smartphones, tablet computers, laptop computers, desktop computers, or other computing devices configured to run user applications (or “apps”). In some embodiments, client device 702 may be substantially similar to devices 103, 105, 107, and 109 of FIG. 1, terminals 240 of FIG. 2, client machines 102a-102n of FIG. 3, computing device 400 of FIG. 4, device 502 of FIG. 5, and/or computing device 602 of FIG. 6, for example.

Client device 702 may have an associated “device profile” (also referred to herein as a “user profile”) that identifies various information about a device (e.g., client device 702), the user to whom the device is assigned, and/or the organization to which the device/user is associated. For example, a device profile may include device information such as manufacture, model name/number, hardware components and capabilities (e.g., processor speed, screen size, network interfaces, etc.), number of monitors (e.g., display devices) operably coupled or attached to the device, capabilities and features of the monitors attached to the device, orientation and configuration of the monitors attached to the device, and a profile of the software installed on the device (e.g., operating system (OS) type and version, a list of apps and app versions installed on the device, etc.). As another example, a device profile can include user information such as the user's name, employee ID, office location, office configuration, role/title with the organization, date of hire, security clearance, etc. As yet another example, a device profile can include information about the organization such as the type of business or other activity the organization is engaged, the industries or sectors the organization operates in, office locations, number of employees or other users associated with the organization, etc. As will be further described below, device profiles may be used, in part, to provide prevention of sensitive content leakage.

Cloud services 704 can include, for example, Software-as-a-Service (SaaS) applications 704a and cloud storage 704b. In an example implementation, cloud service 704 may support many users associated with many different organizations. In some cloud services 704, organizations may correspond to a separate “tenant.” An organization (i.e., users associated with the organization) may store and access various types of content within cloud services 704 including, for example, documents, spreadsheets, databases, web pages, databases, images, and videos. For example, referring to FIG. 7, an organization may upload a document 710 to cloud storage 704b and access document 710 (or information therein) using SaaS application 704a. An organization can store and access sensitive content within cloud services 704. For example, a company may store (e.g., as an attachment) documents within a SaaS application, such as SaaS application 704a, that include confidential information that, if divulged to unauthorized persons, may cause harm (e.g., financial harm) or other undesirable issues.

The term “sensitive content”, or “sensitive information”, or “confidential content”, or “confidential information” is herein used synonymously to include any content or information that is either legally confidential or identified by an individual/organization as being only intended to be seen/viewed by the user themselves, or intended to be seen/viewed by any one or more other persons authorized by this user. Other terms may also be used to refer to content or information that is either legally confidential/sensitive or identified by an individual/organization as being only for the eyes of the user themselves, or any one or more other persons authorized by this user. Non-limiting examples of sensitive content include any data that could potentially be used to identify a particular individual (e.g., a full name, Social Security number, driver's license number, bank account number, passport number, and email address), financial information regarding an individual/organization, information deemed confidential by the individual/organization (e.g., contracts, sales quotes, customer contact information, phone numbers, personal information about employees, and employee compensation information), and information classified by a governing authority as being confidential.

As a solution to the aforementioned and other technical problems related to the display and protection of sensitive content, in some embodiments, client device 702 may be configured to detect when a user is accessing content from cloud services 704 or other resources, including network resources, and determine if the content includes sensitive information, and adjust the display attributes of the sensitive information such that a display of the sensitive information with the adjusted display attributes makes the displayed sensitive information less visible and usable by a user, such as an unintended user, that may be viewing the displayed content. Non-limiting examples of display attributes include size, color, opacity, alpha blending, and/or zoom percentage. Displaying the sensitive information with the adjusted display attributes may prevent leakage or loss of the displayed sensitive content.

In some embodiments, user 708 may access cloud services 704 and other resources, including network resources (e.g., workspace component 608 of content management system 650 of FIG. 6), using a dedicated application 702a installed on client device 702. Application 702a may provide a single-entry point for user 708 to access the organization's resources, such as files, applications, desktops, websites, etc. In one example, application 702a may be the CITRIX WORKSPACE app. In an implementation, application 702a may include a web browser for accessing web-based SaaS applications 704a along with other types of web apps and websites. Application 702a may adjust the display attributes of any sensitive information contained in the accessed content prior to display of the accessed content, including the sensitive information. In some cases, application 702a may be a native web browser application and not the CITRIX WORKSPACE app. In such cases, application 702a may communicate with CITRIX WORKSPACE app via web plugins and/or extensions. In other cases, the CITRIX WORKSPACE app may itself be a web browser.

For example, if user 708 accesses a web page generated by SaaS application 704a via client device 702, client device 702 may identify sensitive information within the web page content (including text and images) and generate a modified web page wherein one or more display attributes of the sensitive information are adjusted to reduce the visibility of the sensitive information when displayed. In this example, document 710 shown in FIG. 7 may represent the original or unmodified web page (i.e., the web page in which the sensitive content has the original or unmodified display attributes) and document 712 may represent the modified web page (i.e., the web page in which the display attributes of the sensitive content have been adjusted or modified). For example, in the case where the sensitive information includes text, adjusting the display attribute may include adjusting the size of the text (e.g., font size) to a smaller size, adjusting the color of the text to a less visible color, adjusting the background color to effectively hide or otherwise make the text less visible, adjusting the opacity to control the transparency of the text, adjusting the alpha blending to blend the foreground text with the background, and/or adjusting the zoom percentage of the area surrounding the sensitive text to a smaller zoom percentage. In the case where the sensitive information includes an image (e.g., an icon), adjusting the display attribute may include adjusting the size of the image to a smaller size, adjusting the color of the image a less visible color, and/or the zoom percentage of the area surrounding the sensitive image to a smaller zoom percentage. In any case, client device 702 may display modified web page 712 to decrease the visibility of the sensitive information contained in document 710.

In an example implementation, SaaS application 704a may utilize an optical character recognition/data loss prevention (OCR/DLP) service 654 of sensitive content management system 650 to determine whether the accessed content (e.g., content to be delivered to user 708 via client device 702) contains any items of sensitive information. The accessed content may be in a text-based format (e.g., textual data) or an image-based format (e.g., an image of the content). In the case of an image, OCR/DLP service 654 may use optical character recognition (OCR) to convert the image of the content to textual data. It will be appreciated that other methods/techniques of text extraction may also be used (e.g., textual data may be embedded in the content and extracted). In any case, OCR/DLP service 654 may scan the accessed content to identify items of sensitive information contained in the content.

For example, OCR/DLP service 654 may scan the textual data for certain keywords or phrases, and/or search the textual data using regular expressions, for patterns of characters to identify items of sensitive information contained in the content being accessed by the user. Non-limiting examples of sensitive information include any data that could potentially be used to identify a particular individual (e.g., a full name, Social Security number, driver's license number, bank account number, passport number, and email address), financial information regarding an individual/organization, and information deemed confidential by the individual/organization (e.g., contracts, sales quotes, customer contact information, phone numbers, personal information about employees, and employee compensation information). Other pattern recognition techniques may be used to identify items of sensitive information.

OCR/DLP service 654 may determine the location of any identified item of sensitive information within the content. For example, in the case of textual content, an OCR process and/or a text extraction process of OCR/DLP service 654 may tag recognized words or characters in the content with location data indicating absolute or relative (e.g., with respect to other display elements) display position data, such as coordinates. Then, for identified items of sensitive information, OCR/DLP service 654 can provide to client device 702, for example, a starting and ending character location which contains the item of sensitive information. In the case of an image, for identified items of sensitive information, OCR/DLP service 654 can provide to client device 702, for example, a location of a bounding rectangle (e.g., coordinates of the four corners of the bounding rectangle) that delineates or defines the bounds (e.g., boundary) of the identified item of sensitive information.

In some embodiments, OCR/DLP service 654 may adjust a display attribute or attributes of the identified items of sensitive information. In such cases, OCR/DLP service 654 may not tag the recognized words or characters in the content with location data.

In some embodiments, an application server, such as virtual apps/desktops 653, may utilize OCR/DLP service 654 of sensitive content management system 650 to determine whether the accessed content (e.g., content to be delivered to user 708 via client device 702) contains any items of sensitive information. In other embodiments, gateway server 606 may utilize OCR/DLP service 654 of sensitive content management system 650 to determine whether the accessed content contains any items of sensitive information. In other implementations, application 702a may utilize a DLP service provided on the client side, such as, for example, on client device 702, to determine whether the accessed content contains sensitive information.

If the accessed content does not contain any sensitive information, client device 702 may cause the content to be displayed without any modification. For example, application 702a may display the accessed content within an application window on a display (e.g., monitor) communicatively coupled to client device 702 for viewing by user 708.

On the other hand, if the accessed content contains one or more items of sensitive information, application 702a may adjust a display attribute or attributes of the items of sensitive information causing the items of sensitive information to be displayed with the adjusted display attributes in the display of the accessed content.

For example, in cases where application 702a is implemented as a web and/or SaaS application, application 702a may utilize event handlers/listeners to receive or otherwise obtain browser navigation and HTML Directory Object Model (DOM) change events. For the HTML elements associated with the identified items of sensitive information, application 702a may save the original display attributes of the items of sensitive information (e.g., original sizes of the items of sensitive information, original colors of the items of sensitive information, original zoom percentage, original look-and-feel, etc.), and adjust a display attribute or attributes of the items of sensitive information in a manner as to decrease the visibility of the items of sensitive information when the accessed content is displayed. For example, application 702a may save the original display attribute data in a suitable storage device accessible to application 702a. Note that saving the original display attribute data allows the items of sensitive information to be displayed using the original display attributes. For example, subsequent to displaying the items of sensitive information using the adjusted display attributes, application 702a may display the items of sensitive information using their original display attributes thus making the sensitive information more visible.

As another example, in some cases, the OCR/DLP may be performed on a virtual desktop agent (VDA). In such cases, the VDA may hook into UI event handlers/listeners to identify and adjust the attributes of the identified items of sensitive information. The VDA may send or otherwise provide remote bitmaps of the items of sensitive content with the adjusted attributes to application 702a. Application 702a may then display the bitmaps provided by the VDA, causing the items of sensitive information to display with the adjusted attributes in a manner as to decrease the visibility of the items of sensitive information when the accessed content is displayed. Subsequently, when user 708 starts interacting with a displayed an item of sensitive information (e.g., user 708 hovers a cursor of a pointing device in the proximity of the displayed item of sensitive information), the UI event handlers may adjust the attributes which results in a new remote bitmap which is sent to application 702a. Application 702a may then display the new remote bitmap (e.g., causing the display of the item of sensitive information with the original attributes).

In some embodiments, application 702a may receive the content with the attribute or attributes of the items of sensitive information already adjusted. For instance, in an implementation, OCR/DLP service 654 may adjust the display attribute or attributes of the identified items of sensitive information. In implementations where an application server, such as virtual apps/desktops 653, utilize OCR/DLP service 654, gateway server 606 may adjust the display attribute or attributes of the items of sensitive information identified by OCR/DLP service 654. In any case, where the attributes of the items of sensitive information contained in the content have already been adjusted, application 702a may proceed with just loading the content for display, for example.

In some embodiments, application 702a may cause an item of sensitive information, which is currently being displayed using the adjusted display attributes, to be displayed using its original display attributes when application 702a determines that user 708 is interacting with the displayed item of sensitive information. For example, an item of sensitive information may be being displayed in an adjusted font size (e.g., 4 point font size) that is smaller than the original font size (e.g., 12 point font size). Application 702a may then detect a cursor of a pointing device, such as a mouse or a pen, being positioned over or in close proximity to the displayed item of sensitive information. For example, user 708 may hover the cursor of the mouse over the displayed item of sensitive information. This may be an indication that user 708 is interacting with the displayed item of sensitive information and application 702a may cause the item of sensitive information to be displayed in its original font size (e.g., 12 point font size). Application 702a may subsequently determine that user 708 is no longer interacting with the item of sensitive information that is being displayed in 12 point font size (e.g., in its original display attributes). For example, user 708 may hover the cursor of the mouse to an area of the display that is not over or proximate the displayed item of sensitive information. This may be an indication that user 708 is not or no longer interacting with the displayed item of sensitive information and application 702a may cause the item of sensitive information to again be displayed in its adjusted font size (e.g., 4 point font size).

In cases where there are multiple items of sensitive information, the items of sensitive information that user 708 is not interacting with may continue to be displayed using the adjusted display attributes. For example, suppose there are four items of sensitive information, item A, item B, item C, and item D, being displayed using adjusted display attributes. In this example case, if application 702a detects user 708 interacting with item A, application 702a may cause item A to be displayed using its original attributes while continuing the display of items B, C, and D using their adjusted attributes. Subsequently, if application 702a detects user 708 interacting with item B, application 702a may cause item B to be displayed using its original attributes. In some embodiments, application 702a may cause item A, with which user 708 is no longer interacting, to be displayed using its adjusted display attributes. In other embodiments, application 702a may continue the display of item A using its original display attributes. In some embodiments, if an item of sensitive information is being displayed using its adjusted display attributes in an application window, other items of sensitive information being displayed in the same application window are displayed using their adjusted display attributes. Conversely, if an item of sensitive information is being displayed using its original display attributes in an application window, other items of sensitive information being displayed in the same application window are displayed using their original display attributes.

In an embodiment, the user's facial movement (e.g., facial movement of user 708) may be used to determine whether user 708 is interacting or not interacting with the displayed item of sensitive information. Client device 702 may include or be operably coupled to an image capture device, such as a camera or webcam, which may be used to capture images of user 708 and, more particularly, the face of user 708. For example, client device 702 may include a machine learning model, such as OpenCV or other suitable computer vision library, which may be used to determine facial attributes, such as the data points for the nose, eyes, jaw, etc. of user 708 in the captured images.

In order to properly determine whether the facial attributes (e.g., data points) captured in an image or images of user 708 show or indicate that user 708 is viewing (looking at) a monitor, such as a monitor that is displaying an item of sensitive information, client device 702 may first perform a calibration procedure to obtain ground truth or reference data. Client device 702 may perform the calibration procedure when user 708 first utilizes a monitor operably coupled or attached to client device 702. For example, client device 702 can identify a particular monitor that user 708 is interacting with based on the detected pointing device (e.g., mouse) and/or keyboard interactions. While detecting the pointing device and/or keyboard interactions, client device 702 may utilize the image capture device to capture the facial movement of user 708. Client device 702 can then associate the range of detected pointing device and/or keyboard interactions with the range of facial attributes in the captured images of user 708 to generate ground truth or reference data that indicates user 708 is viewing the particular monitor. Client device 702 can then use the ground truth or reference data generated for a particular monitor to determine whether the facial attributes of user 708 captured in an image or images (for example, subsequently captured images) and the subsequently detected pointing device and/or keyboard interactions show or indicate that user 708 is viewing the particular monitor. It will be appreciated in light of this disclosure that the calibration procedure may but need not be performed when a user first utilizes a monitor. Rather, client device 702 may perform the calibration procedure to obtain the ground truth or reference data at any time client device 702 detects that the user is utilizing a monitor. Further note that the calibration procedure may be performed multiple times (e.g., at various times throughout the day or time period).

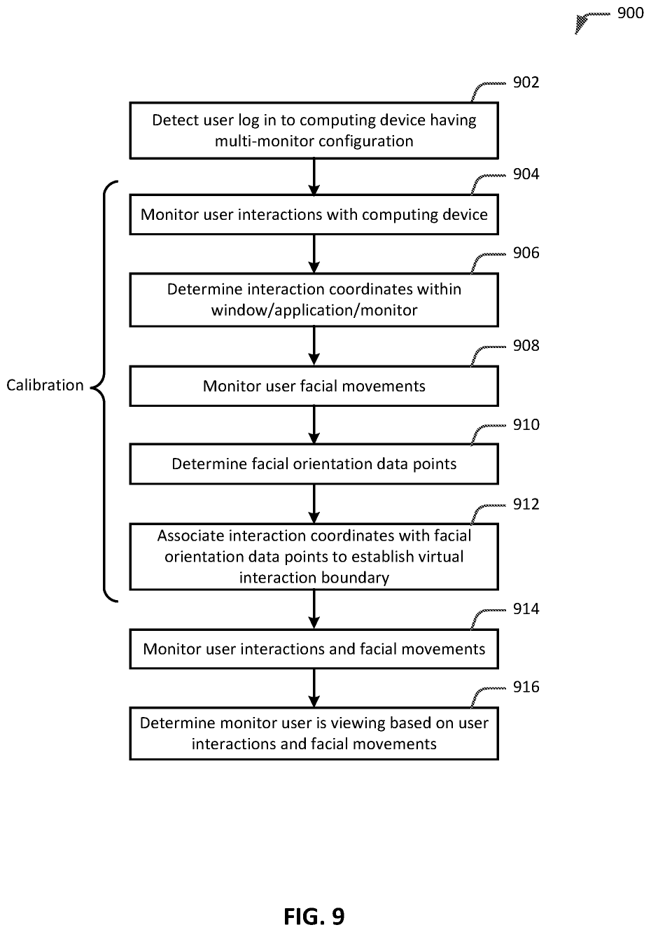

The concept of facial recognition with machine learning is well understood in the fields of facial recognition, machine learning, and deep neural networks and will not be discussed in detail here. However, for purposes of this discussion, it is sufficient to understand that the trained machine learning model may operate to determine from a comparison of a user's interaction data and facial attributes to ground truth or reference data obtained during a calibration phase whether the user is viewing a monitor and/or interacting with the item of sensitive information being displayed on the monitor. If it is determined that user 708 is viewing and/or interacting with the displayed item of sensitive information, application 702a may cause the item of sensitive information to be displayed with its original display attributes (e.g., displayed in its original font size, original color, original zoom percentage, and/or original look-and-feel). If it is determined that user 708 is not viewing and thus not interacting with the displayed item of sensitive information, application 702a may cause the item of sensitive information to be displayed with its adjusted display attributes (e.g., displayed in a font size that is smaller than the original font size, displayed in a color that causes the item of sensitive information to be less visible when compared to the item of sensitive information displayed in its original color, displayed in a zoom percentage that is smaller than the original zoom percentage, and/or displayed in a look-and-feel that is less visible than the original look-and-feel). Determining a monitor being viewed using a user's facial movements is further described below at least in conjunction with FIG. 9.

In an embodiment, the user's eye movement (e.g., eye movement of user 708) may be used to determine whether user 708 is interacting or not interacting with the displayed item of sensitive information. For example, client device 702 may include or be operably coupled to an eye tracking device that can be used to measure the eye positions and eye movement of user 708. Based on the measured information, it may be determined whether user 708 is looking at and interacting with the displayed item of sensitive information or not looking at and thus not interacting with the displayed item of sensitive information.

In some embodiments, application 702a may adjust the display attribute or attributes of an item of sensitive information contained in the accessed content based on the presence or physical proximity of another user (e.g., a user other than user 708) to the display of the accessed content. For example, if client device 702 that is displaying the sensitive content does not detect the presence of another user in the physical proximity of the display of the sensitive content, application 702a may display the items of sensitive information with its original display attributes. However, if client device 702 detects another user in the physical proximity of the display of the accessed content, application 702a may adjust a display attribute or attributes of the item of sensitive information causing the item of sensitive information to be displayed with the adjusted display attributes in the display of the accessed content.

In an embodiment, a virtual boundary (e.g., a “geofencing boundary”) may be configured or otherwise established for client device 702. The boundary may define a physical region or zone (i.e., a security zone) around client device 702, and client device 702 may be able to detect electronic devices within the security zone (i.e., the virtual boundary). For example, in some such embodiments, the geofencing boundary may be configured around client device 702 using a location-based service enabled application or software. Such location-based service enabled applications may use Global Positioning System (GPS), radio frequency identification (RFID), Wi-Fi, or cellular data to trigger a programmed action when a mobile device or RFID tag enters or exits the geofencing boundary set up around client device 702.

For example, when another user having or otherwise in possession of an enrolled device, such as an enrolled mobile device 502 of FIG. 5, enters the boundary, the enrolled device of the other user may generate an alert or other notification. This alert may be transmitted to and/or received by client device 702. Additionally or alternatively, this alert may be transmitted to another device, such as enterprise mobility management system 500 of FIG. 5, configured or designated to receive the alert. In any case, the generated alert allows for detection of the other user within the physical proximity to client device 702. For purposes of this discussion, it is sufficient to understand that a device's location can be used to determine whether that device is within physical proximity of another device on which sensitive information is being displayed based on the defined boundary.

In some embodiments, a beacon, such as a Bluetooth beacon or a Bluetooth Low Energy beacon, may be used to configure or otherwise establish a security zone around client device 702. Client device 702 may then be able to detect electronic devices that are within the established security zone (i.e., detect electronic devices that are sufficiently proximate to client device 702). For example, when another user having or otherwise in possession of an enrolled device, such as an enrolled mobile device 502, comes within range of the beacon's signal transmissions, the enrolled device of the other user may be able to determine from the strength of the signal transmissions (received signal strength indicator (RSSI) levels) that the device is within the security zone. The enrolled device of the other user may then provide a notification of its presence within the security zone to client device 702. Based on the received notification, client device 702 may determine that the other user is within physical proximity.

In some embodiments, client device 702 may include an image capture device, such as a webcam. Client device 702 can then detect the presence of other users in the physical proximity of client device 702 from the image or video data provided by the image capture device. For example, in some such embodiments, the image capture device may be configured to capture images or videos when sensitive information is being displayed on a display of client device 702. Such detection may be useful in cases where other users are not carrying or otherwise have in their possession enrolled mobile devices, such as an enrolled mobile device 502.

In some embodiments, image capture devices, such as webcams and surveillance cameras, may be deployed in locations around client device 702. The deployed image capture devices may be communicatively coupled to client device 702, thus allowing client device 702 to detect the presence of other users in the physical proximity of client device 702 from the images or videos captured by the image capture devices. Again, such detection may be useful in cases where other users are not carrying or otherwise have in their possession enrolled mobile devices, such as an enrolled mobile device 502.

In some embodiments, application 702a may adjust a display attribute of an item of sensitive information based on contextual factors, such as the degree of sensitivity of the sensitive information and the relative closeness of a detected user (e.g., a user other than user 708) to the display of the sensitive information. For example, financial information, such as a bank account number, may be deemed more sensitive than contact information, such as an email address. In this case, client application 702 may adjust the font of a displayed bank account number to a smaller font size (e.g., 6 point font size) than that of a displayed email address (e.g. adjust the font of the email address to 8 point font size).

The relative closeness of a detected user to the display of sensitive information may be determined using various techniques. For example, as described previously, the physical proximity of another user to the display of sensitive information may be detected using the signals transmitted by a mobile device, such as an enrolled mobile device 502, being carried by or in the possession of the other user. When such a mobile device determines from the RSSI levels that it is within a configured security zone around client device 702, the mobile device provides a notification (e.g., a notification signal including information such as, by way of example, identifying information regarding a user who is using the mobile device, identifying information regarding the mobile device, and/or the RSSI value) of its presence within the security zone to client device 702. Upon receiving the notification, client device 702 can compute or otherwise determine an estimated distance of the detected user to the display of sensitive information (i.e., client device 702) based on the RSSI level of the notification signal. Application 702a may then adjust a display attribute of the displayed item of sensitive information based on the estimated distance of the detected user to the display of sensitive information. For example, if the detected user is determined to be 20 meters from the display, client application 702 may adjust the font of the displayed item of sensitive information to 8 point font size. If the detected user is determined to be 10 meters from the display, client application 702 may adjust the font of the displayed item of sensitive information to 6 point font size.

In some embodiments, the item of sensitive information being displayed with adjusted display attributes may be displayed with its original display attributes on a mobile device associated with user 708 using client device 702 to display the content including the item of sensitive information. For example, user 708 may be in possession of an enrolled mobile device, such as enrolled mobile device 502. As such, mobile device management system 500 may maintain a record of user 708 and the enrolled mobile device associated with user 708. This allows mobile device management system 500 to manage the mobile device associated with user 708 through the application of mobile management policies. One such policy may cause the enrolled mobile device of user 708 to display the item of sensitive information, which is being displayed with adjusted display attributes on client device 702, with its normal display attributes. This allows user 708 to view the sensitive information displayed with normal display attributes on the user's mobile device while the item of sensitive information is being displayed with adjusted display attributes on client device 702 and thus, protected from leakage or loss. In an embodiment, a check is first made to determine whether mobile device 502 is in the proximity of client device 702. If mobile device 52 is within proximity of client device 702, mobile device 502 displays the item of sensitive information, which is being displayed with adjusted display attributes on client device 702, with its normal display attributes.

In some embodiments, application 702a may be configured to provide a print preview feature that displays items of sensitive information using their original display attributes. For example, application 702a may be running on client device 702 and displaying content that includes an item of sensitive information. The item of sensitive information may be being displayed with its adjusted display attributes. Prior to adjusting the display attributes, application 702a may save the original display attributes associated with the item of sensitive information. Wanting to review what the displayed content will look like when printed, user 708 may click or activate a print preview icon. Activating the print preview icon may display a print preview dialog box that displays the content and, particularly, the item of sensitive information using its original attributes. In other words, although the item of sensitive information is being displayed using its adjusted display attributes on client device 702, the same item of sensitive information is displayed using its original display attributes in the print preview dialog box. Thus, application 702a provides a print preview that displays an accurate depiction of what the content, including the item of sensitive information, will look like when printed.

For example, in cases where application 702a is implemented as a web and/or SaaS application, application 702a may use print media cascading style sheets (CSS) to change the appearance of the items of sensitive information in the print preview from the appearance of the items of sensitive information outside of the print preview. For example, in an implementation, application 702a may retrieve the saved original display attributes associated with the items of sensitive information. Application 702a may then use the original display attributes to generate print media CSS that changes the appearance of the items of sensitive content to their original display attributes. Application 702a can then use the generated print media CSS (the CSS generated using the original display attributes) to display the items of sensitive information with their original display attributes in the print preview dialog box.

In cases where application 702a and, in particular, the print preview feature, is implemented using Chromium Embedded Framework (CEF), application 702a may inject JavaScript (JS) objects to change the appearance of the items of sensitive information in the print preview from the appearance of the items of sensitive information outside of the print preview. The JS events ‘onbeforeprint’ and ‘onafterprint’ can be used to manipulate the appearance of the items of sensitive information for printing. For example, application 702a can use the JS event listener ‘onbeforeprint’ to change the DOM content associated with the items of sensitive information to the original display attributes while print preview is being performed, and use the JS event listener ‘onafterprint’ to return the DOM content for the items of sensitive information to the adjusted display attributes after the print.

In cases where application 702a is implemented as a Chromium browser (also referred to simply as Chrome), application 702a may hook into the browser's print functionality. The Chrome print preview feature includes frontend work to provide the desired interactive user experience and backend work to generate the PDF files and communicate to the printers. For example, to provide a print preview (e.g., upon user 708 clicking or activating a print icon in a Chrome window), a renderer instance associated with the browser process retrieves from the browser process the current printer settings and generates a PDF for the print preview using the retrieved printer settings. The PDF for the print preview displays the items of sensitive information using their original display attributes. The renderer then sends the generated PDF to the browser, which displays the PDF (i.e., the print preview) for viewing, for example, by user 708. If user 708 changes the printer settings, then the browser can send the changed printer settings to the renderer with a request for a new PDF for previewing. This process may be repeated until user 708 completes the print preview process (e.g., user 708 is satisfied with the print preview), after which the browser sends the final version of the PDF to the printer. Note that the final version of the PDF includes the items of sensitive information displayed using their original display attributes.

In cases where the print preview functionality is being invoked in the target application being accessed, such as a virtualized Windows app, the print preview workflow may vary based on whether the printing is to a locally attached printer (i.e., a printer connected to an endpoint client, such as client device 702) or to a network printer (i.e., a printer managed by a print server, such as Citrix Print Server, provided by Citrix Systems, Inc.). If printing is to a locally attached printer, an application server, such as virtual apps/desktops 653, may send a print command and data via a virtual channel to client device 702. In an implementation, the application server may compress the print data and send the compressed print data to client device 702. Upon receiving the print command and data, client device 702 can send the print command and data to the locally attached printer. In the case where the print data is compressed by the server side, client device 702 can decompress the print data and send the decompressed print data to the locally attached printer. For the print preview feature, the application server can generate the print preview data. If the print preview data includes items of sensitive information, these items of sensitive information are included in the data using their original attributes. The application server can then send the print preview data to client device 702. Application 702a on client device 702 can then invoke a print preview utility or component to display the print preview data provided by the application server.

If printing is to a network printer, the application server may send a print command and data (also known as a print job) to the print server. Upon receiving the print job, the print server can send the print command and print data to the network-based printer. In an implementation, the application server may compress the print data and send the compressed print data to the print server. In the case of compressed data, the print server can decompress the print data, and send the print command and decompressed print data to the network-based printer. Alternatively, the application server may send the print job via a virtual channel to client device 702, and client device 702 can send the print job to the print server. In any case, for the print preview feature, the application server can generate the print preview data. If the print preview data includes items of sensitive information, these items of sensitive information are included in the data using their original attributes. The application server can then send the print preview data to client device 702. Application 702a on client device 702 can then invoke a print preview utility or component to display the print preview data provided by the application server.

In some embodiments, an application window is opened or displayed on a monitor that has relatively less (and ideally least) potential for data loss or leakage. This may be particularly beneficial in cases where a user, such as user 708, is using a multi-monitor setup (i.e., client device 702 is coupled to multiple monitors). Determination of the specific monitor on which to open or display an application window may be based on contextual factors such as a state of the environment surrounding client device 702 (i.e., a state of the environment in which the application window is being (or will be) opened or displayed), the multi-monitor layout, and the capabilities of the monitors. To this end, content management system 650 may be aware of the layout or mapping of the environment around client device 702 such as the location of client device 702, the configuration of the monitors coupled to client device 702 (e.g., number of monitors, layout of the monitors (e.g., flat layout, tilted or angled layout, etc.), features of the monitors (e.g., monitor includes an external filter, etc.), and locations and layout of other client devices and workstations physically proximate to client device 702. Content management system 650 may also be aware of the presence of other users at or in the physical proximity of the other devices and workstations physically proximate to client device 702 and whether any of these other users are watching or observing beyond their monitors (e.g., watching or observing a monitor coupled to client device 702). Content management system 650 may provide such information to client device 702 for use in determining the monitor on which to open or display an application window. For example, application 702a may use the provided information to identify an appropriate monitor of the multiple monitors coupled to client device 702 and open or display the application window on the identified monitor.

In some embodiments, a mapping and positioning application or service may be used to generate a layout of the environment surrounding client device 702. The layout may include or otherwise provide information such as the location of client device 702 (e.g., client device 702 is located in a private office, client device 702 is located by a window or wall to the left of, right of, front of, and/or behind client device 702, etc.), the number of monitors coupled to client device 702, the layout of the monitors coupled to client device 702, and the layout of other client devices and workstations near client device 702 (e.g., neighboring client devices or workstations to the left, right, front, and/or behind client device 702). In some embodiments, deployed image capture devices, such as webcams and surveillance cameras, may capture images or videos, which may be used to determine a layout of the environment surrounding client device 702. The deployed image capture devices may be used to determine the presence of other users in the physical proximity of client device 702. For example, the other users may be using the client devices and workstations physically proximate to client device 702. Content management system 650 may provide to client device 702 the information regarding the layout of the environment surrounding 702 and the users detected in the environment.

In some embodiments, image capture devices, such as webcams and surveillance cameras, may be deployed in locations around client device 702. The deployed image capture devices may capture images or videos of the multi-monitor setup of client device 702. For example, to determine the layout and features of the monitors, image processing and machine learning (ML) models can be used to perform image segmentation to identify the monitors in the images. The image segmentation may also provide the respective coordinates of the identified monitors. The coordinates can then be used to number the respective monitors (e.g., the monitors coupled to client device 702 may be numbered 1 to N starting from the top-left monitor and proceeding right in the x-direction and then down in the y-direction). A ML model can be used to classify the respective screen of the identified monitors (i.e., the monitor screens) as having an external filter or not having an external filter. For example, the ML model can be trained to classify a monitor into one of two categories: a monitor having a filter and a monitor having no filter. In some cases, a user, such as user 708 or other authorized user, may provide information as to whether a monitor has an external filter. In any case, content management system 650 may provide to client device 702 the information regarding the monitor layout and features.

In some embodiments, client device 702 may be configured to determine the features of the monitors coupled client device 702. For example, application 702a, or other suitable application on client device 702, may determine the features and capabilities of the monitors from the client device 702 device profile. Application 702a may query the OS running on client device 702, for example, via an appropriate OS API, to determine the features and capabilities of the monitors from the client device 702. Application 702a may also query a vendor provided API, such as an API provided by the vendor of the monitors, to determine the features and capabilities of the monitors from the client device 702. In any case, application 702a can determine information regarding the features and capabilities of the monitors, such as whether the monitors include inbuilt filters, information regarding monitor settings such as color, brightness, and contrast, and information regarding the state of the windows displayed on the monitors, such as whether a windows is hidden, partially hidden, or fully visible, to name a few examples.

In some embodiments, computing devices, such as the devices and workstations in the vicinity of client device 702, may be programmed or otherwise configured to determine information regarding users using the computing devices and provide such information to content management system 650. Content management system 650 can then send or otherwise provide the information regarding the users to client device 702. For example, a computing device can determine whether a user using the computing device is watching or observing beyond the monitor coupled to the computing device. Such information can be determined from analysis of images of the user captured by image capture devices in the vicinity of the computing device. For instance, as described previously, the facial attributes captured in the images of the user may indicate either that the user is watching the monitor coupled to the computing device or watching something other than the monitor coupled to the computing device. The computing device can make the determination as to whether the user is or is not looking at the monitor coupled to the computing device and provide such information to content management system 650. Upon receiving such information, content management system 650 can identify the other devices proximate to the computing device at which the user is watching beyond the monitor, such as client device 702, and notify the identified devices of the potential for data loss or leakage. For instance, content management system 650 can identify the proximate devices from a layout or mapping of the environment. Upon receiving such notification, client device 702 may provide an alert (e.g., an audible alert and/or a visible alert) to notify its user, such as user 708, of the potential for data loss or leakage. In an embodiment, client device 702 may adjust the display attributes (e.g., color, brightness, etc.) of a monitor that is displaying sensitive information thus making the displayed sensitive information more difficult to view.

To reduce (and ideally eliminate) the potential for data loss or leakage, in an embodiment, computing device 702 can determine whether other users, such as users using the devices and workstations in the vicinity of client device 702, are proximate to client device 702. If no other users are proximate to client device 702, an application window may be opened or displayed on a monitor coupled to client device 702. In the case where there are multiple monitors coupled to client device 702, the application window may be opened or displayed on a monitor that has or includes a filter. In the case where multiple monitors have filters, a monitor having an orientation that makes it difficult for a nearby user to view may be selected. In other words, the application window is opened or displayed on a monitor of the multiple monitors that is least viewable by the nearby user. For example, suppose client device 702 is located next to a window on the right side of client device 702. Also suppose that there is another workstation on the left side of client device 702. In this example case, an application window may be opened or displayed on a monitor that is oriented away from the workstation (e.g., angled to the right) on the left of client device 702 thus making it difficult for a user at or using the workstation to view the displayed application window.

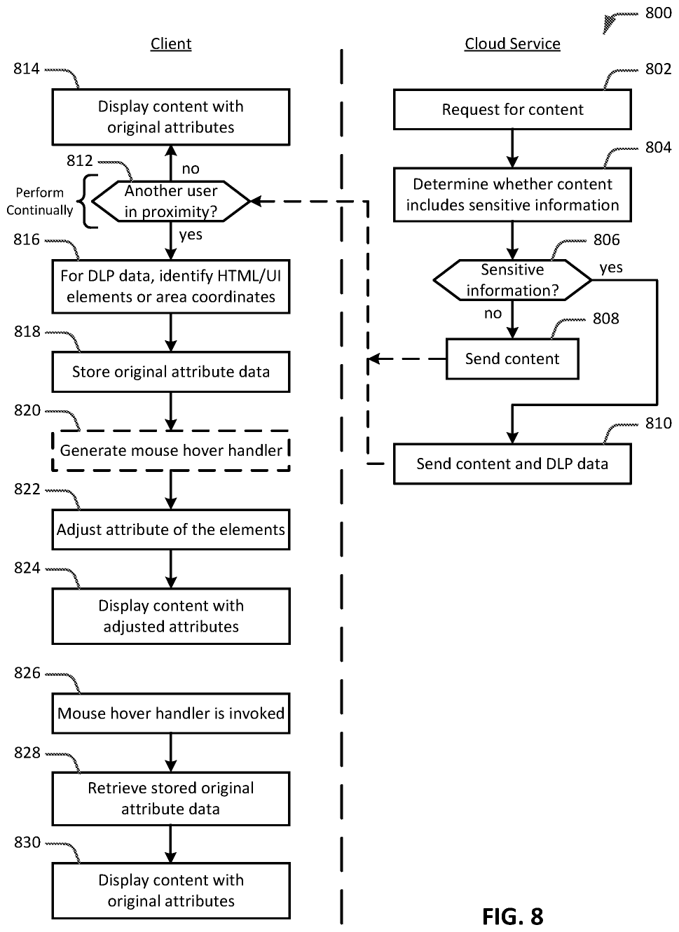

FIG. 8 is a flow diagram of an example process 800 for display of sensitive information based on physical proximity, in accordance with an embodiment of the present disclosure. Example process 800, and example process 900 further described below, may be implemented or used within a computing environment such as those disclosed above at least with respect to FIG. 5, FIG. 6, and/or FIG. 7. Further, in some embodiments, the operations, functions, or actions illustrated in example process 800, and example process 900 further described below, may be stored as computer-executable instructions in a computer-readable medium, such as volatile memory 406 and/or non-volatile memory 408 of computing device 400 of FIG. 4 (e.g., computer-readable medium of components 103, 105, 107, and 109 of FIG. 1, computing device 201 and terminals 240 of FIG. 2, and/or client machines 102a-102n of FIG. 3). For example, the operations, functions, or actions described in the respective blocks of example process 800, and example process 900 further described below, may be implemented by applications 412 and/or data 414 of computing device 400.

With reference to example process 800 of FIG. 8, at 802, a content system, such as cloud service 704, may receive a request for content. For example, a user, such as user 708, may use application software, such as application 702a, running on a computing device, such as client device 702, to access content provided by cloud service 704.

In response to the access for content, at 804, cloud service 704 may check to determine whether the requested content includes sensitive information. For example, in an implementation, cloud service may utilize an optical character recognition/data loss prevention (OCR/DLP) service, such as OCR/DLP 654 of FIG. 6, to determine whether the requested content contains any items of sensitive information. At 806, if a determination is made that the content does not contain sensitive information, then, at 808, cloud service 704 may send the content in its original form to client device 702. Cloud service 704 may also provide an indication that the content does not contain any items of sensitive information.

If a determination is made that the content contains one or more items of sensitive information, then, at 810, cloud service 704 may send the content and associated DLP data that includes information regarding the identified items of sensitive information. For example, in an implementation, cloud service 704 may send the content in its original form with DLP data that provides information regarding the location of the identified items of sensitive information in the content.

Client device 702 may receive the content from cloud service 704. At 812, client device 702 may determine whether another user is in physical proximity (i.e., whether another user is in physical proximity of client device 702). If a determination is made that there are no other users in physical proximity, then, at 814, client device 702 and, more particularly, application 702a, may display the content, including the contained items of sensitive information, with their original display attributes. For example, application 702a may display the content in an application window displayed on a monitor coupled to client device 702.

Otherwise, if a determination is made that another user is in physical proximity, then, at 816, client device 702 may identify the HTML/UI elements and/or area coordinates associated the items of sensitive information specified by the DLP data. At 818, client device 702 may store the original display attributes of the identified HTML/UI elements and/or area coordinates (i.e., save the original display attributes of the identified items of sensitive information).

At 820, client device 702 may optionally generate mouse hover handlers for the identified HTML/UI elements and content areas defined by the area coordinates. A mouse hover handler generated for a HTML/UI element or content area define a trigger area (trigger area for the HTML/UI element or area coordinates) and is activated when a pointing device, such as a mouse or a digital pen, moves or hovers over the defined trigger area.

At 822, client device 702 may adjust the display attribute or attributes (e.g., font size, color, opacity, alpha blending, and/or zoom percentage) of the HTML/UI elements and content area defined by the area coordinates in a manner as to decrease the visibility of these HTML/UI elements and content areas defined by the area coordinates when the content is displayed. At 824, client device 702 may display the content on a monitor coupled to client device 702. The items of sensitive information contained in the displayed content are shown with their adjusted display attributes.

At 826, client device 702 may determine that a mouse hover handler is invoked. For example, user 708 may have moved or otherwise positioned a mouse over a trigger area defined for an item of sensitive information that is being displayed with its adjusted display attributes. At 828, client device 702 may retrieve the original display attributes of the item of sensitive information associated with the invoked mouse hover handler. At 830, client device 702 may display the item of sensitive information with its original display attributes.

In an implementation, client device 702 may continually and/or periodically check to determine whether another user is in physical proximity (i.e., whether another user is in physical proximity of client device 702). For instance, the physical proximity of client device 702 may be continually and/or periodically checked as long as sensitive information is being displayed on or by client device 702. This allows for adjusting the display attributes of the displayed items of sensitive information to decrease the visibility of the sensitive information upon determining that another user is in physical proximity. This also allows for displaying the items of sensitive information with their original display attributes when another user is not in physical proximity of client device 702.

In some embodiments, at 812, client device 702 may optionally determine whether another user is in physical proximity of client device 702. For example, client device 702 may identify the items of sensitive information, store the original display attributes of the items of sensitive information, adjust the display attributes of the items of sensitive information, and display the items of sensitive information with the adjusted display attributes regardless of the presence of other users in physical proximity of client device 702. In some such embodiments, if client device 702 detects or otherwise determines that user 708 is interacting with a displayed item of sensitive information, client device 702 may display the item of sensitive information using its original display attributes.

FIG. 9 is a flow diagram of an example process 900 for determining a monitor a user is viewing, in accordance with an embodiment of the present disclosure. Although the following description of process 900 may refer to a client device having a multi-monitor setup, it will be appreciated in light of this disclosure that process 900 can be applied to client devices having a single monitor.

With reference to example process 900 of FIG. 9, at 902, a computing device, such as client device 702, may detect a user, such as user 708, logging in to an application, such as application 702a, on client device 702. Client device 702 may be coupled to multiple monitors arranged in a multi-monitor setup and include an image capture device. User 708 may interact with one of the multiple monitors to log in to application 702a on client device 702. Application 702a has knowledge of the monitors coupled to client device 702 and which application windows and/or applications are being displayed on which monitors.

At 904, client device 702 may perform an initial calibration by monitoring user 708 interactions with application 702a on computing device 702. In brief, the initial calibration may include determining the monitor user 708 is interacting with and correlating user 708 interaction data with image capture device monitored data (i.e., facial attribute data obtained from images of user 708 captured by the image capture device).

At 906, interaction coordinates within an application window of application 702a, application 702a, or a monitor on which the application window is being displayed are determined. The determined coordinates define a range of locations or positions on the monitor display at which interaction with the application window of application 702a, application 702a, or the monitor is detected. For example, application 702a may monitor the pointing device and/or keyboard input events to determine the range of interaction coordinates.

At 908, the facial movements of user 708 may be monitored. For example, the image capture device coupled to client device 702 may capture images of user 708 to monitor the facial movements. At 910, facial orientation data points for user 708 may be determined. Client device 702 may analyze the captured images to determine the facial attributes, such as the data points for the nose, eyes, jaw, etc. of user 708. These facial attributes define a range of facial orientation point values at which user 708 was interacting with client device 702 and, more specifically, application 702a on computing device 702. In an implementation, the range of facial orientation point values (i.e., the facial attributes) may be determined using a machine learning model, such as OpenCV or other suitable computer vision library.

At 912, the range of interaction coordinates is associated with the range of facial orientation point values to establish a virtual interaction boundary. The associated range of interaction coordinates and range of facial orientation point values define a virtual interaction boundary for a particular monitor (i.e., the monitor for which the calibration is being performed). For example, a detected interaction coordinate and/or facial orientation point value outside the range of interaction coordinates and range of facial orientation point values used to establish the virtual interaction boundary for a particular monitor may be an indication that user 708 is not interacting with the particular monitor. Conversely, a detected interaction coordinate and/or facial orientation point value within the range of interaction coordinates and range of facial orientation point values used to establish the virtual interaction boundary for a particular monitor may be an indication that user 708 is interacting with the particular monitor.

In an implementation, client device 702 may perform an initial calibration (blocks 904-912) for each of the multiple monitors coupled to client device 702. For instance, the initial calibration may be performed when user 708 first interacts with a particular monitor to establish a virtual interaction boundary for the particular monitor.

At 914, client device 702 may continually and/or periodically monitor user 708 interactions with client device 702 (e.g., interaction coordinates within an application window of application 702a, application 702a, or the monitor on which the application window is being displayed) and facial movements (e.g., facial orientation point values) while interacting with client device 702. At 916, client device 702 may determine the particular monitor that user 708 is viewing based on the monitored user interactions and facial movements and the established virtual interaction boundaries for the multiple monitors coupled to client device 702.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
receiving, by a first computing device, content for display, the first computing device associated with a first user; and
responsive to a determination that the content for display includes at least one item of sensitive information,
adjusting, by the first computing device, at least one display attribute of the at least one item of sensitive information; and
displaying, by the first computing device, the at least one item of sensitive information with the adjusted at least one display attribute.

2. The method of claim 1, wherein the at least one item of sensitive information is associated with a first font size and adjusting the at least one display attribute of the at least one item of sensitive information comprises adjusting the at least one item of sensitive information to a second font size, the second font size being different than the first font size.

3. The method of claim 2, wherein the second font size is based on a proximity of a second user to the first computing device.

4. The method of claim 1, wherein the at least one item of sensitive information is associated with a first font color and adjusting the at least one display attribute of the at least one item of sensitive information comprises adjusting the at least one item of sensitive information to a second font color, the second font color being different than the first font color.

5. The method of claim 1, wherein the at least one item of sensitive information is associated with a first zoom percentage and adjusting the at least one display attribute of the at least one item of sensitive information comprises adjusting the at least one item of sensitive information to a second zoom percentage, the second zoom percentage being different than the first zoom percentage.

6. The method of claim 1, wherein adjusting the at least one display attribute of the at least one item of sensitive information is responsive to determining, by the first computing device, that a second user is physically proximate the first computing device.

7. The method of claim 6, wherein determining that the second user is physically proximate the first computing device comprises determining whether a second computing device associated with the second user is physically proximate the first computing device.

8. The method of claim 6, wherein determining that the second user is physically proximate the first computing device includes use of image capture.

9. The method of claim 1, wherein adjusting the at least one display attribute of the at least one item of sensitive information is responsive to determining, by the first computing device, that the first user is no longer interacting with the displayed at least one item of sensitive information.

10. The method of claim 9, wherein determining that the first user is no longer interacting with the displayed at least one item of sensitive information includes use of facial recognition.

11. The method of claim 9, wherein determining that the first user is no longer interacting with the displayed at least one item of sensitive information includes determining that a cursor of a pointing device is no longer proximate the displayed at least one item of sensitive information.

12. The method of claim 1, wherein the at least one item of sensitive information is associated with a first display attribute and adjusting the at least one display attribute of the at least one item of sensitive information comprises adjusting the at least one item of sensitive information to a second display attribute, the method further comprising:
determining that the first user is interacting with the displayed at least one item of sensitive information; and
displaying the at least one item of sensitive information with the first display attribute.

13. The method of claim 12, wherein determining that the first user is interacting with the displayed at least one item of sensitive information includes use of facial recognition.

14. The method of claim 12, wherein determining that the first user is interacting with the displayed at least one item of sensitive information includes determining that a cursor of a pointing device is proximate the displayed at least one item of sensitive information.

15. The method of claim 1, wherein the at least one item of sensitive information is associated with a first display attribute and adjusting the at least one display attribute of the at least one item of sensitive information comprises adjusting the at least one item of sensitive information to a second display attribute, the method further comprising:
responsive to a print command, displaying, by the first computing device, a print preview displaying the at least one item of sensitive information with the first display attribute.

16. The method of claim 1, wherein the at least one item of sensitive information is associated with a first display attribute, the method further comprising:
responsive to a determination that the content for display includes at least one item of sensitive information, displaying, by the first computing device, the at least one item of sensitive information with the first display attribute on a mobile computing device associated with the first user.

17. A non-transitory machine-readable medium encoding instructions that when executed by one or more processors cause a process to be carried out, the process comprising:
receiving content for display, the content for display requested by a user; and
responsive to a determination that the content for display includes at least one item of sensitive information,
adjusting at least one display attribute of the at least one item of sensitive information; and
causing displaying of the at least one item of sensitive information with the adjusted at least one display attribute.

18. The non-transitory machine-readable medium of claim 17, wherein the at least one display attribute includes one of a font size, a font color, opacity, alpha blending, or a zoom percentage.

19. The non-transitory machine-readable medium of claim 17, wherein adjusting the at least one display attribute of the at least one item of sensitive information is responsive to determining that the user is no longer interacting with the displayed at least one item of sensitive information.

20. A method comprising:
receiving, by a computing device, content for display, the computing device associated with a first user, the computing device coupled to a plurality of monitors; and
responsive to a determination that the content for display includes at least one item of sensitive information,
determining whether a second user is physically proximate the computing device; and
responsive to a determination that the second user is physically proximate the computing device,
identifying a monitor of the plurality of monitors that is least viewable by the second user; and
displaying the content on the identified monitor.
